(19) United States
(12) Patent Application Publication
(10) Pub. No.: US 2021/0155012 A1
(43) Pub. Date: May 27, 2021

(54) INKJET PRINTING DEVICE AND INKJET PRINTING METHOD

(71) Applicants: Hiroshi GOTOU, Kanagawa (JP); Hiroaki TAKAHASHI, Kanagawa (JP); Yuta NAKAMURA, Kanagawa (JP); Yuusuke KOIZUKA, Kanagawa (JP); Ayaka TANAKA, Kanagawa (JP)

(72) Inventors: Hiroshi GOTOU, Kanagawa (JP); Hiroaki TAKAHASHI, Kanagawa (JP); Yuta NAKAMURA, Kanagawa (JP); Yuusuke KOIZUKA, Kanagawa (JP); Ayaka TANAKA, Kanagawa (JP)

(21) Appl. No.: 16/953,611

(22) Filed: Nov. 20, 2020

(30) Foreign Application Priority Data
Nov. 25, 2019 (JP) 2019-211966
Oct. 15, 2020 (JP) 2020-173794

(51) Int. Cl. B41J 11/00; B41J 2/14; B41M 5/00; B41M 7/00

(52) U.S. Cl. CPC B41J 11/002; B41M 7/009; B41M 5/0023; B41J 2/1433

(57) ABSTRACT

An inkjet printing device includes an ink container accommodating a clear ink containing a resin and an organic solvent, a discharging head including a nozzle plate, the discharging head being configured to discharge the clear ink onto a substrate to form a printing layer on the substrate, and a heating device configured to heat the substrate, wherein the heating device heats the substrate satisfying the following relationship:

Tₘₐₜₜₑ (degrees C.)>T_{gloss} (degrees C.), where Tₘₐₜₜₑ represents a temperature of the substrate in a first printing region when the clear ink is attached to the substrate in a first printing mode and T_{gloss} represents a temperature of the substrate in a second printing region when the clear ink is attached to the substrate in a second printing mode, wherein the receding contact angle of the clear ink against the nozzle plate is 35 degrees or greater.

### CROSS-REFERENCE TO RELATED APPLICATIONS

This patent application is based on and claims priority pursuant to 35 U.S.C. § 119 to Japanese Patent Application Nos. 2019-211966 and 2020-173794, filed on Nov. 25, 2019 and Oct. 15, 2020, respectively, in the Japan Patent Office, the entire disclosures of which are hereby incorporated by reference herein.

### BACKGROUND

### Technical Field

The present invention relates to an inkjet printing device and an inkjet printing method.

### Description of the Related Art

Media such as non-permeable recording media including plastic film are used for advertisements and signboards and packaging material for food, beverages, and daily commodities that require resistance to light, water, abrasion, and the like. Naturally, various inks for such recording media have been long developed.

Such inks are widely used and include solvent-based inks using organic solvents as solvents and ultraviolet (UV)-curable inks containing polymerizable monomers as the main component. However, evaporation of the organic solvents contained in the solvent-based inks raises environment concerns. Also, the polymerizable monomers usable in the UV curing inks are limited in some cases because of safety reasons.

For this reason, ink sets including aqueous ink that have a low environmental impact and can be directly applied to non-permeable recording media have been proposed.

Inkjet recording devices capable of controlling gloss have also been developed.

### SUMMARY

According to embodiments of the present disclosure, an inkjet printing device is provided which includes an ink container accommodating a clear ink containing a resin and an organic solvent, a discharging head including a nozzle plate, the discharging head being configured to discharge the clear ink onto a substrate to form a printing layer on the substrate, and a heating device configured to heat the substrate, wherein the heating device heats the substrate satisfying the following relationship: Tₘₐₜₜₑ (degrees C.)>T_{gloss} (degrees C.), where Tₘₐₜₜₑ represents the temperature of the substrate in a first printing region when the clear ink is attached to the substrate in a first printing mode and T_{gloss} represents the temperature of the substrate in a second printing region when the clear ink is attached to the substrate in a second printing mode, wherein the receding contact angle of the clear ink against the nozzle plate is 35 degrees or greater.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of the inkjet printing device executing the inkjet printing method according to an embodiment of the present disclosure;

FIG. 2 is a diagram illustrating a perspective view of an example of a tank of the inkjet printing device illustrated in FIG. 1; and

FIG. 3 is a diagram illustrating an explosive perspective view of an example of the ink discharging head of the inkjet printing device according to an embodiment of the present disclosure;

FIG. 4 is a diagram illustrating an example of the ink discharging head in the inkjet printing device according to an embodiment of the present disclosure;

FIG. 5 is a diagram illustrating a cross sectional surface of the ink discharging head along the latitudinal direction of a liquid chamber;

FIG. 6 is a diagram illustrating an example of the ink discharging head in the inkjet printing device according to an embodiment of the present disclosure;

FIG. 7 is a diagram illustrating a cross sectional surface of the nozzle plate illustrated in FIG. 6;

FIG. 8 is a diagram illustrating an enlarged cross sectional surface of a nozzle portion of the nozzle plate illustrated in FIG. 8; and

FIG. 9 is a diagram illustrating the inside of an inkjet printing device.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an inkjet printing device is provided which can impart gloss in two modes of low gloss (matte) and high gloss and stably discharges ink.

Inkjet Printing Device and Inkjet Printing Method

The inkjet printing device of the present disclosure includes an ink container accommodating a clear ink comprising a resin and an organic solvent, a discharging head including a nozzle plate, the discharging head being configured to discharge the clear ink onto a substrate to form a printing layer on the substrate, and a heating device configured to heat the substrate, wherein the heating device heats the substrate satisfying the following relationship: Tₘₐₜₜₑ (degrees C.)>T_{gloss} (degrees C.), where Tₘₐₜₜₑ represents the temperature of the substrate in a first printing region when the clear ink is attached to the substrate in a first printing mode and T_{gloss} represents the temperature of the substrate in a second printing region when the clear ink is attached to the substrate in a second printing mode, wherein the receding contact angle of the clear ink against the nozzle plate is 35 degrees or greater.

The first printing mode is to apply low gloss and also referred to as low gloss printing mode. The second printing mode is to apply high gloss and also referred to as high gloss printing mode.

The inkjet printing method of the present disclosure includes discharging a clear ink from an ink discharging head including a nozzle plate to a substrate to form a printing layer and heating the substrate on which the printing layer has been formed, wherein the clear ink contains a resin and water, wherein, in the heating, the heating device heats the substrate satisfying the following relationship: Tₘₐₜₜₑ (degrees C.)>T_{gloss} (degrees C.), where Tₘₐₜₜₑ represents the temperature of the substrate in a first printing region when the clear ink is attached to the substrate in a first printing mode and T_{gloss} represents the temperature of the substrate in a second printing region when the clear ink is attached to the substrate in a second printing mode, wherein the receding contact angle of the clear ink against the nozzle plate is 35 degrees or greater.

The first printing mode is to apply low gloss and also referred to as low gloss printing mode. The second printing mode is to apply high gloss and also referred to as high gloss printing mode.

A method of controlling the degree of gloss by controlling the level of irradiation has been proposed by which an inkjet printing device imparts matte (low gloss) or gloss (high gloss) using clear ink that is cured upon irradiation of ultraviolet (UV) radiation.

However, printed matter formed with UV clear ink has the problem of strong odor that remains on the printed matter. Therefore, it is not suitable for indoor use. For this reason, the use of an inkjet printing device is limited to places with sufficient ventilation. In addition, UV clear ink requires an ultraviolet irradiator, which increases the size and cost of the inkjet printing device.

Also, the typical technology has not succeeded in optimizing the receding contact angle of clear ink against the nozzle plate of an ink discharging head. Ink is readily wet on the repellent ink film of the nozzle plate of an ink discharging head in such an inkjet printing device and adheres to the nozzle, thereby degrading discharging stability.

The receding contact angle of the clear ink against the nozzle plate of an ink discharging head is 35 degrees or greater in the present disclosure. Under this receding contact angle, the ink repellent film of the nozzle plate of a discharging head tends to be wet so that the ink attached to the wall surface of the ink chamber of an ink discharging head is readily repelled, thereby enhancing discharging stability.

Clear ink is uniformly applied to a substrate by printing even on substrates having different ink wettability due to the receding contact angle in this specific range of the clear ink against a nozzle plate. The difference of the degree of gloss becomes significant by uniform application of the clear ink so that gloss can be suitably controlled.

The inkjet printing device and the inkjet printing method of the present disclosure control both the low gloss and high gloss of a printed product by adjusting the heating temperature using a clear ink that contains a resin and water. The temperature at which low gloss is imparted during printing is set to be higher than the temperature at which high gloss is imparted. The dots of the clear ink containing the resin minimally spread because the temperature during printing is sufficiently high to keep dots adjacent to each other from readily merging and to make the height of dot spheres (pile height) high. These dots form a rough surface, resulting in a printed product with low gloss.

To impart high gloss to a print product, the clear ink is applied at temperatures during printing lower than the temperatures at which low gloss is imparted. This lower printing temperature makes the clear ink containing the resin spread more widely and merge with adjacent dots, which results in a print product with a smooth surface with high gloss.

The inkjet printing device of the present disclosure uses a clear ink containing a resin and water and has a low gloss printing mode to impart low gloss to a print product and a high gloss printing mode to impart high gloss to it. This degree of gloss is controlled by a heating device under the following condition: Tₘₐₜₜₑ (degrees C.)>T_{gloss} (degrees C.), where Tₘₐₜₜₑ represents the temperature of a substrate in the matte printing region printed in the low gloss printing mode when the clear ink is attached to the substrate and T_{gloss} represents the temperature of a substrate in the gloss printing region printed in the high gloss printing mode when the clear ink is attached to the substrate to achieve gloss control of low gloss and high gloss.

The heating device of the inkjet printing device of the present disclosure heats the substrate satisfying the following relationship: Tₘₐₜₜₑ>T_{gloss} and preferably Tₘₐₜₜₑ−T_{gloss}≥10 degrees C. It is more preferable that the heating device in the inkjet printing device heats the substrate to satisfy the following relationship: Tₘₐₜₜₑ−T_{gloss}≥20 degrees C.

The temperature of the heating device in the low gloss printing mode is sufficiently high to prevent dots from spreading and to make the height of dot spheres (pile height) high to form a rough surface. In contrast, the heating temperature in the high gloss printing mode is sufficiently low to promote spreading of dots and merging with adjacent dots, thereby forming a smooth surface.

Tₘₐₜₜₑ of the substrate in the printing region in the low gloss printing mode is preferably 50 degrees C. or higher, more preferably from 50 to 80 degrees C., and furthermore preferably from 64 to 68 degrees C.

T_{gloss} of the substrate in the printing region in the high gloss printing mode is preferably 70 degrees C. or lower and more preferably 60 degrees C. or lower. The heating temperature is furthermore preferably from 40 to 60 degrees C. and particularly preferably from 49 to 59 degrees C.

Within this temperature range, the inkjet printing device can significantly change the gloss using a clear ink in each printing mode

The temperature of the substrate in the printing region can be measured by methods such as a method of directly measuring the temperature of the recording medium as the substrate with a thermocouple provided to the recording medium, a method of measuring the temperature of the heater that heats the recording medium and defining it as the temperature of the recording medium, and a method of measuring the ambient temperature of the recording medium in a non-contacting manner by a radiation thermometer and defining it as the temperature of the recording medium.

In the present disclosure, when the print ratio of a low gloss print image printed in the low gloss printing mode is Dₘₐₜₜₑ and the print ratio of a high gloss print image printed in the high gloss printing mode is D_{gloss}, the following relationship is preferably satisfied: D_{gloss}>Dₘₐₜₜₑ and more preferably D_{gloss}−Dₘₐₜₜₑ>10 percent. The inkjet printing device is easy to form a smooth surface with a high printing ratio so that images with a high printing ratio are obtained in the high gloss printing mode. On the other hand, the inkjet printing device produces images with a low printing ratio in the low gloss printing mode when the printing ratio is high because adjacent dots merge, which prevents forming a rough surface.

The printing ratio is represented by the following.

Printing ratio (percent)={(number of printed dots of clear ink)/(longitudinal resolution×latitudinal resolution)}×100

The number of printed dots of clear ink means the number of dots of clear ink actually applied per unit of area and longitudinal resolution and latitudinal resolution each represent resolutions per unit of area. When the clear ink is overlapped on the same dot position, the number of printed dots of clear ink means the number of dots of clear ink actually applied per unit of area.

The printing ratio of 100 percent means the maximum mass of single color ink to a pixel.

The ink discharging head for use in the inkjet printing device of the present disclosure is described next.

Ink Discharging Head

The ink discharging head has a nozzle plate and other optional members.

Nozzle Plate

The nozzle plate has a nozzle substrate and an ink repellent film on the nozzle substrate.

Nozzle Substrate

The nozzle substrate has nozzles and the number, shape, size, material, and structure thereof are not particularly limited and can be suitably selected to suit to a particular application.

The nozzle substrate has a surface on the ink discharging side from which the ink is discharged through the nozzle and a liquid chamber bonding surface located on the opposite side to the surface on the ink discharge side.

The ink repellent film is formed on the surface on the ink discharging side of the nozzle substrate and located between the nozzle substrate and a substrate. The receding contact angle of the clear ink against the surface facing the substrate is 35 degrees or greater.

The planar form of the nozzle substrate is not particularly limited and can be suitably selected to suit to a particular application. Examples include a rectangle, a square, a rhombus, a circle, and an ellipse.

The cross section of the nozzle substrate may be a flat plate-like shape or plate-like shape.

There is no specific limit to the size and form of the nozzle substrate and it can be suitably selected to suit to the size of the nozzle plate.

There is no particular limit to the material for the nozzle substrate and it can be suitably selected to suit to a particular application.

Specific examples include, but are not limited to, Al, Bi, Cr, InSn, ITO, Nb, Nb₂O₅, NiCr, Si, SiO₂, Sn, Ta₂O₅, Ti, W, ZAO(ZnO+Al₂O₃), and Zn. These can be used alone or in combination. Of these, stainless steel is preferable to prevent rust.

There is no specific limitation to stainless steel and it can be suitably selected to suit to a particular application. Specific examples include, but are not limited to, austenite-based stainless steel, ferrite-based stainless steel, martensite-based stainless steel, and precipitation curing-based stainless steel. These can be used alone or in combination.

At least the surface of the nozzle substrate on the ink discharging side may be subjected to oxygen plasma treatment to introduce hydroxyl groups in terms of improving the attachability between the ink repellent film and the nozzle substrate.

Nozzle

The nozzle is not particularly limited with respect to the number, arrangement, spacing, opening form, opening size, cross-section form of the opening, etc. The nozzle is not particularly limited and can be suitably selected to suit to a particular application.

The arrangement of the nozzles is not particularly limited and can be suitably selected to suit to a particular application. For example, a plurality of the nozzles can be equally spaced along the length direction of the nozzle substrate.

The arrangement of the nozzle holes can be appropriately selected according to the type of ink to be discharged. For example, it is preferably from one to a plurality of ranks and more preferably one to four ranks.

The number of the nozzle per rank is not particularly limited and can be suitably select to suit to a particular application. For example, the number is preferably from 10 to 10,000 and more preferably from 50 to 500.

The pitch P, which is the minimum distance between the centers of adjacent nozzles, is not particularly limited and can be suitably selected to suit to a particular application. For example, it is preferably from 21 to 169 km.

The form of the aperture of the nozzle is not particularly limited and can be suitably selected to suit to a particular application. For example, circular, elliptical, and square are suitable. Of these, a circular shape is preferable to suitably discharge ink droplets.

Ink Repellent Film

The ink repellent film preferably contains a fluorinated polyacrylate or a polymer having a fluorinated heterocyclic structure in the main chain.

When the ink repellent film contains a fluorinated polyacrylate or a polymer having a fluorinated heterocyclic structure in the main chain, the surface free energy becomes extremely small. This is preferable because even the ink having a low surface tension for use in the present disclosure can maintain a non-wettable state. However, when materials other than a fluorinated polyacrylate or a polymer having a fluorinated heterocyclic structure in the main chain are used for a ink repellent film, the surface free energy becomes extremely small so that the ink having a low surface tension for use in the present disclosure may be wet on the ink repellent film.

Fluorinated Polyacrylate

The fluorinated polyacrylate preferably contains at least one of a compound represented by the following Chemical Formula I and a compound represented by the following Chemical Formula II as a monomer unit.

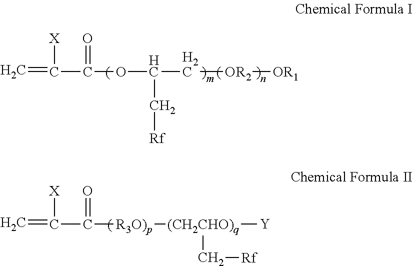

In Chemical Formula I and Chemical Formula II, X represents a hydrogen atom, linear or branched alkyl group having 1 to 21 carbon atoms, halogen atom, CFX₁X₂ group (where X₁ and X₂ each, respectively represent hydrogen atoms and halogen atoms), cyano group, linear or branched fluoroalkyl group having 1 to 21 carbon atoms, substituted or non-substituted benzyl group, and substituted or non-substituted phenyl group. R₁ represents an alkyl group having 1 to 18 carbon atoms. R₂ is an alkylene group having 2 to 6 carbon atoms. R₃ is an alkylene group having 2 to 6 carbon atoms. Y is an acid group. Rf is a linear or branched fluoroalkyl group having 1 to 21 carbon atoms. m represents an integer of from 1 to 10, n represents an integer of from 2 to 90, p represents an integer of from 1 to 90, and q represents an integer of from 1 to 10.

The polymer obtained by polymerizing at least one of the compound represented by Chemical Formula I and the compound represented by Chemical Formula II has at least one of the structural unit represented by the following Chemical Formula III and the structural unit represented by the following Chemical Formula IV

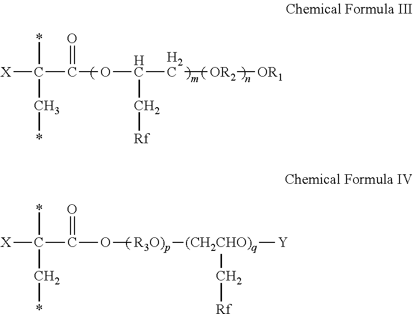

In Chemical Formula III and Chemical Formula IV, X represents a hydrogen atom, linear or branched alkyl group having 1 to 21 carbon atoms, halogen atom, CFX₁X₂ group (where X₁ and X₂ each, respectively represent hydrogen atoms and halogen atoms), cyano group, linear or branched fluoroalkyl group having 1 to 21 carbon atoms, substituted or non-substituted benzyl group, and substituted or non-substituted phenyl group. R₁ represents an alkyl group having 1 to 18 carbon atoms. R₂ is an alkylene group having 2 to 6 carbon atoms. R₃ is an alkylene group having 2 to 6 carbon atoms. Y is an acid group. Rf is a linear or branched fluoroalkyl group having 1 to 21 carbon atoms. m represents an integer of from 1 to 10, n represents an integer of from 2 to 90, p represents an integer of from 1 to 90, and q represents an integer of from 1 to 10.

The R₁ mentioned above preferably has 1 to 18 carbon atoms, more preferably 1 to 4 carbon atoms. Specific examples include, but are not limited to, a methyl group, ethyl group, propyl group, butyl group, pentyl group, hexyl group, heptyl group, octyl group, nonyl group, decyl group, and undecyl group.

The R₂ mentioned above is an alkylene group having 2 to 6 carbon atoms. Specific examples include, but are not limited to, an ethylene group, propylene group, and butylene group. Of these, R₂ is preferably an ethylene group.

The R₃ mentioned above is an alkylene group having 2 to 6 carbon atoms. Specific examples include, but are not limited to, an ethylene group, propylene group, and butylene group. Of these, R₃ is preferably an ethylene group.

Y is an acid group such as a sulfonic acid group, a succinic acid group, an acetic acid group, a phthalic acid group, a hydrogenated phthalic acid group, and a maleic acid group.

Rf is a linear or branched fluoroalkyl group having 1 to 21 carbon atoms, preferably a perfluoroalkyl group, and more preferably Rf has 1 to 10 carbon atoms.

As the Rf mentioned above, examples include, but are not limited to, —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂, —(CF₂)₇CF₃, —(CF₂)₅CF(CF₃)₂, —(CF₂)₆CF(CF₃)₂, and —(CF₂)₉CF₃.

The m mentioned above is preferably from 1 to 10 and more preferably from 1 to 3.

The n mentioned above is preferably from 2 to 90, more preferably from 3 to 50, and furthermore preferably from 4 to 30. The p mentioned above is preferably from 1 to 90 and more preferably from 1 to 30.

The q mentioned above is preferably from 1 to 10 and more preferably from 1 to 3.

The fluorinated polyacrylate is suitably synthesized or procured.

The fluorinated polyacrylate (where Rf is C₆F₁₃) represented by the Chemical Formula II can be synthesized by, for example, the following reaction formula.

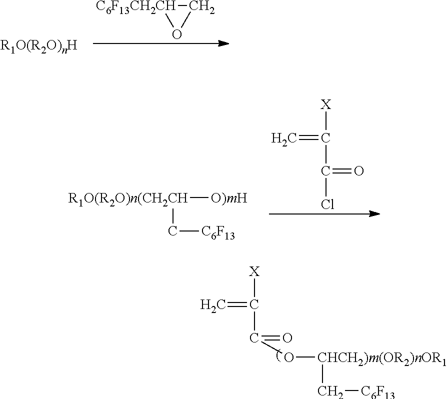

In the reaction formula, R₁, X, m, and n each represent the same as above for the Chemical Formula III.

The fluorinated polyacrylate (where Rf is C₆F₁₃) represented by the Chemical Formula II can be synthesized by, for example, the following reaction formula.

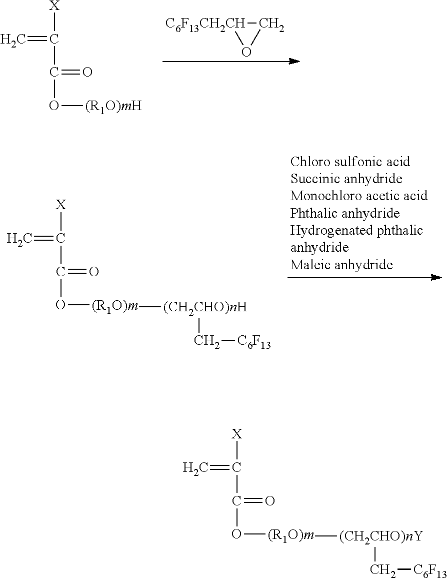

In the reaction formula, R₁, X, m, and n each represent the same as above for the Chemical Formula III.

The proportion of fluorine in the fluorinated polyacrylate is preferably 10 percent by mass or more, more preferably 25 percent by mass or more, and furthermore preferably 50 percent by mass or more in terms of ink repellency (contact angle).

Specific examples of the commercially available products include, but are not limited to, KRYTOX F SL (manufactured by E.I. du Pont de Nemours and Company), KRYTOX FSH (manufactured by E.I. du Pont de Nemours and Company), FOMBLIN Z (manufactured by Solvay Solexis), FLUOROLINKS10 (manufactured by Solvay Solexis), OPTOOL DSX (manufactured by DAIKIN INDUSTRIES, LTD.), FLUOROLINKC10 (manufactured by Solvay Solexis), Morescophospharol A20H (manufactured by Matsumura Oil Co., Ltd.), Morescophospharol ADOH (manufactured by Matsumura Oil Co., Ltd.), Morescophospharol DDOH (manufactured by Matsumura Oil Co., Ltd.), Fluorosurf FG5010 (manufactured by Fluoro Technology), Fluorosurf FG5020 (manufactured by Fluoro Technology), and Fluorosurf FG5070 (manufactured by Fluoro Technology).

The ink repellent film is formed of film of a compound containing the fluorinated polyacrylate skeleton in the molecule.

An inorganic oxide layer can be provided between the nozzle substrate and the ink repellent film in order to improve attachability by allowing a large number of hydroxyl groups present as the bonding point with the compound containing a fluorinated polyacrylate skeleton in the molecule.

Specific examples of the material of the inorganic oxide layer include, but are not limited to, SiO₂ and TiO₂.

The average thickness of the inorganic oxide layer is preferably from 0.001 to 0.2 μm and more preferably from 0.01 to 0.1 μm.

Examples of the compound containing a fluorinated polyacrylate backbone in the molecule include, but are not limited to, low-molecular substances and resins.

Specific examples of the compound containing a fluorinated polyacrylate skeleton in the molecule are disclosed in, for example, JP-H3-43065-A1, JP-H6-210857-A1, JP-H10-32984-A1, JP-2000-94567-A1, JP-2002-145645-A1, JP-2003-341070-A1, JP-2007-106024-A1, and JP 2007-125849-A1.

Of these, modified perfluoropolyoxethane (OPTOOL DSX, manufactured by DAIKIN INDUSTRIES, LTD.) is preferable as the compound having a fluorinated polyacrylate backbone in the molecule.

The average thickness of the ink repellent film is preferably from 0.001 to 0.2 μm and more preferably from 0.01 to 0.1 μm.

Examples of the method of forming an ink repellent film using a compound containing a fluorinated polyacrylate skeleton in the molecule include, but are not limited to, dipping, printing, and vacuum deposition by, for example, spin coating, roll coating, and dipping using a fluorinated solvent.

As the fluorinated solvent, Novec™ (manufactured by 3M Company), Vertrel® (manufactured by E. I. du Pont de Nemours and Company), and Galden® (manufactured by Solvay Solexis) can be used.

Polymer Having Fluorinated Heterocyclic Structure in Main Chain

The polymer having a fluorinated heterocyclic structure in the main chain is particularly preferably an amorphous polymer.

The amorphous polymer is excellent in film strength, attachability to a substrate, which is advantageous to demonstrate the effects of the present disclosure.

The polymer having a fluorinated heterocyclic structure in the main chain disclosed in, for example, U.S. Pat. Nos. 3,418,302, 3,978,030, JP-S63-238111-A1, JP-563-238115-A1, JP-H1-131214-A1, and JP-H1-131215 are preferably used. Of these, the following polymers having heterocyclic structure are representative as the polymers containing fluorinated heterocyclic structure in the main chain. These are not limiting the polymers containing fluorinated heterocyclic structural unit in the main chain.

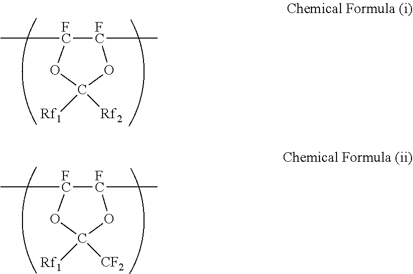

In Chemical Formula (i) and Chemical Formula (ii), Rf₁, Rf₂, and Rf₃ each, independently represent fluorinated alkyl groups.

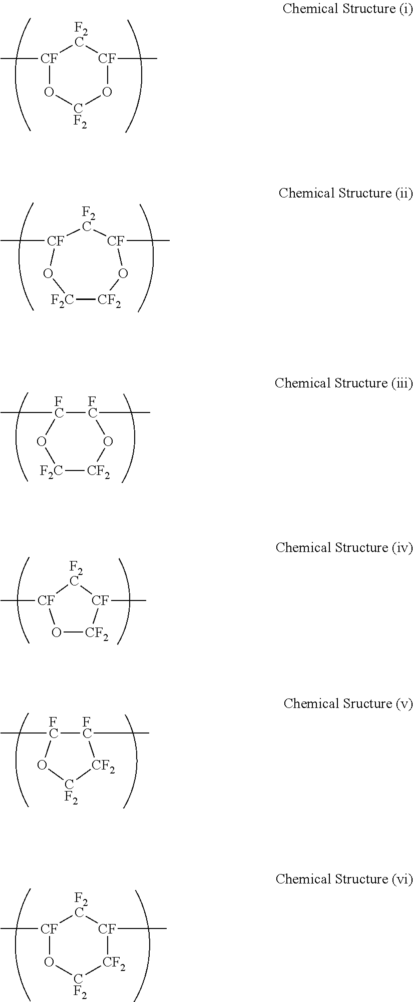

The structure represented by the following Chemical Formula (iii) may be introduced into the main chain to improve adhesion with a substrate and control the glass transition temperature, and solubility in a solvent. The structure represented by Chemical Formula (iii) is obtained by copolymerizing comonomers represented by the following Chemical Structure (vii) to the Following Chemical Structure (ix).

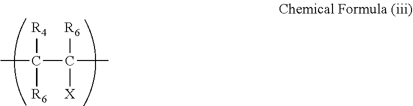

In the Chemical Formula (iii), R₄, R₅, and R₆ each, independently represent hydrogen atoms, fluorine atoms, chlorine atoms, or Rf₄.

The Rf₄ mentioned above is a fluorinated alkyl group.

X represents a hydrogen atom, a fluorine atom, a chlorine atom, Rf₅ or Rf₆.

The Rf₅ mentioned above is a fluorinated organic substituent having a functional group such as an acid, an ester, an alcohol, an amine, or an amide at the terminal and the Rf₆ mentioned above is a fluorinated alkyl group or a fluorinated ether group.

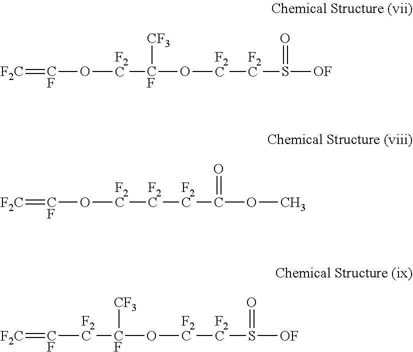

Examples of those having a specific chemical structure described above and suitable as an ink repellent agent include, but are not limited to, CYTOP CTX-105 (manufactured by ASAHI GLASS CO., LTD.) and CYTOP CTX-805 (manufactured by ASAHI GLASS CO., LTD.), and Teflon® AF1600 and AF2400, manufactured by E.I. du Pont de Nemours and Company).

Examples of the method of forming an ink repellent film using a polymer having a fluorinated heterocyclic structure in the main chain include, but are not limited to, dipping, printing, and vacuum deposition by, for example, spin coating, roll coating, and dipping using a fluorinated solvent.

The fluorinated solvent is not particularly limited as long as it can dissolve the polymer having a fluorinated heterocyclic structure in the main chain and can be suitably selected to suit to a particular application. Specific examples include, but are not limited to, perfluorobenzene (Aflud®, fluorinated solvent, manufactured by ASAHI GLASS CO., LTD.), Fluorinert FC-75 (liquid containing perfluoro(2-butyl tetrahydrofuran, manufactured by 3M Company). These can be used alone or in combination. Of these, in the case of a mixed solvent, a hydrocarbon, a chlorinated hydrocarbon, a fluorinated hydrocarbon, an alcohol, or another organic solvent can be used in combination.

The solution concentration is preferably from 0.01 to 50 percent by mass and more preferably from 0.01 to 20 percent by mass. The ink repellent film having an average thickness of from 0.01 μm or greater is sufficient to achieve the object described above. Preferably, it is from 0.01 to 2 μm.

The heat treatment conditions (temperature) of the polymer having a fluorinated heterocyclic structure in the main chain are determined by the boiling point of the solvent, the glass transition temperature of the polymer, and the heat-resistant temperature of the substrate. That is, it is suitable to set a temperature higher than the boiling point of the solvent and the glass transition temperature of the polymer and lower than the heat resistance temperature of the substrate.

The glass transition temperature of the polymer having a fluorinated heterocyclic structure in the main chain varies depending on the structure.

For example, many of the structures represented by the Chemical structure (iv) to the Chemical structure (vi) have a glass transition temperature of from 50 to 110 degrees. Therefore, the temperature range is preferably from 120 to 170 degrees and the heating time is preferably from 30 minutes to two hours.

In addition, a copolymer having the structure of the Chemical Formula (ii) and the structure of the following Chemical structure (x) in the main chain is available from E.T. du Pont de Nemours and Company, which is Teflon® AF.

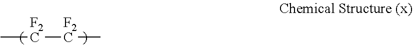

The glass transition temperature of Teflon® AF can be changed by changing its copolymerization ratio. That is, as the ratio of the [perfluoro(2,2-dimethyl-1,3-dioxole)] (PDD) component increases, the glass transition temperature rises. The Teflon® AF can have a glass transition temperature of from 80 to 330 degrees C. depending on the ratio of the PDD component. Teflon® AF 1600 having a glass transition temperature of 160 degree C. and Teflon® AF 2400 having a glass transition temperature of 240 degree C. are procurable. For example, the heat treatment temperature of AF1600 is preferably from 165 to 180 degrees C. considering the heat resistance temperature of a substrate.

Other Members

The other members are not particularly limited and can be suitably selected to suit to a particular application. Examples include, but are not limited to, a pressurizing chamber and a stimulus generating device.

Pressurizing Chamber

The pressurizing member is disposed corresponding to each of the individual nozzles provided to the nozzle plate. The pressurizing chamber is individual flow paths communicating with the nozzles and also referred to as ink flow path, pressurizing liquid chamber, pressure chamber, discharging chamber, and liquid chamber.

Device for Discharging Ink

The ink discharging head includes a device that generates a stimulus to be applied to an ink.

The stimulus generated by the stimulus generating device has no specific limit and can be suitably selected to a particular application. For example, heat (temperature), pressure, vibration, and light can be suitably used as the stimulus.

These can be used alone or in combination.

Of these stimuli, heat and pressure are preferable.

Examples of the stimulus generating device include, but are not limited to, a heater, a pressurizing device, a piezoelectric element, a vibrator, an ultrasonic oscillator, and light.

Specific examples include, but are not limited to, a piezoelectric actuator such as the piezoelectric element, a thermal actuator that utilizes a phase change caused by film boiling of ink using an electric heat conversion element such as a heat generating resistance, a shape-memory alloy actuator that uses the metal phase change due to temperature change, and an electrostatic actuator that utilizes an electrostatic force.

When the stimulus is heat, a thermal energy is applied to ink in the ink discharging head in response to recording signals by a device such as a thermal head.

Bubbles are generated in the ink due to the thermal energy and the ink is discharged as liquid droplets from the nozzles by the pressure of the bubbles.

When the stimulus is pressure, a voltage is applied to the piezoelectric element attached at the position referred to as the pressure chamber disposed in the ink flow path in the ink discharging head so that the piezoelectric element bends.

Owing to this bend, the pressure chamber shrinks, so that the ink is discharged from the nozzle of the ink discharging head.

When pressure is utilized as the stimulus, the piezoelectric method is preferable in which the ink is jetted by applying a voltage to a piezoelectric element.

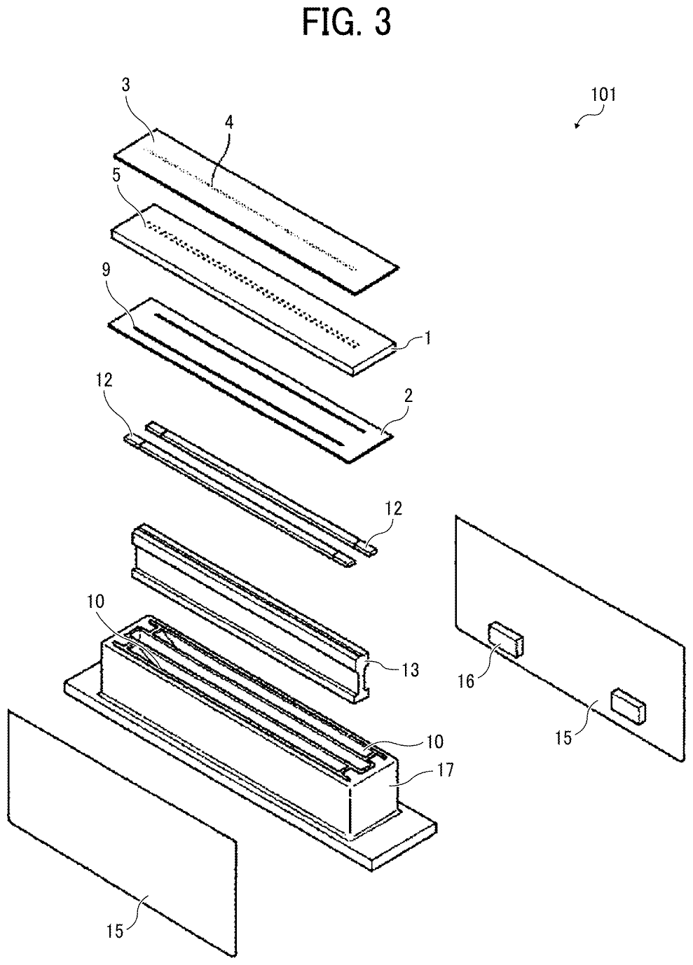

Next, an example of the inkjet discharging head for use in the present disclosure will be described with reference to FIG. 3 to FIG. 8.

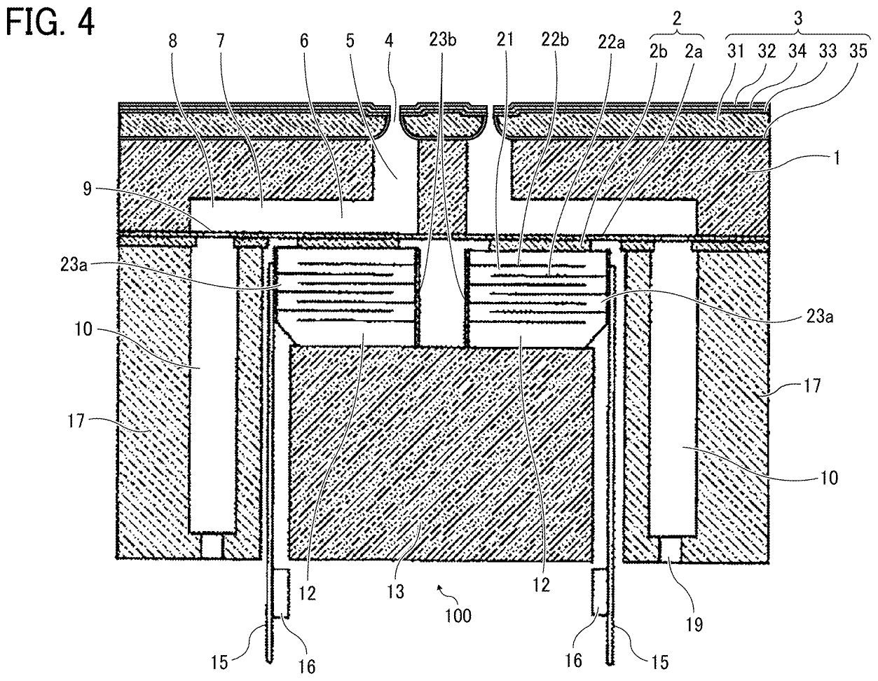

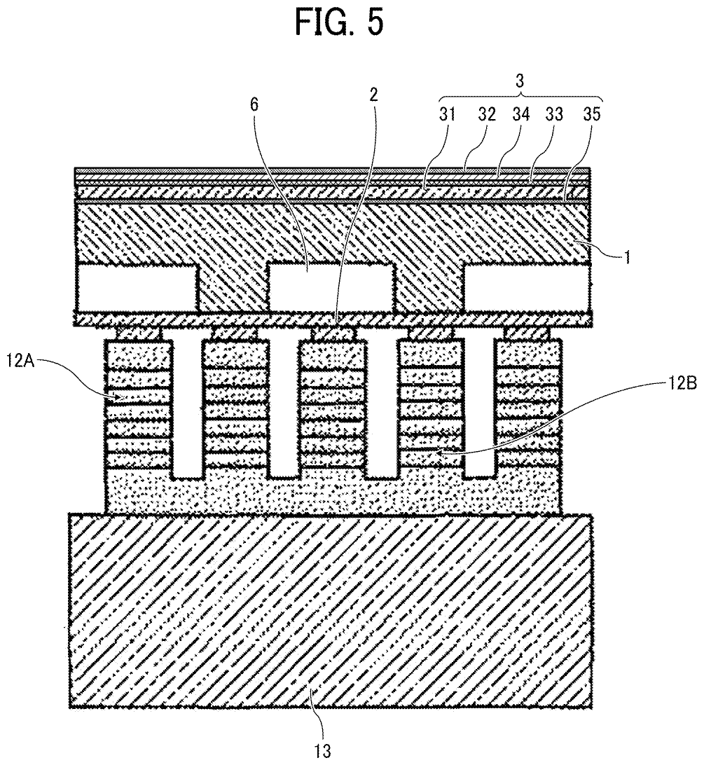

FIG. 3 is a diagram illustrating an exploded perspective view of an ink discharging head 101, FIG. 4 is a diagram illustrating a cross section along the direction (longitudinal direction of liquid chamber) perpendicular to the nozzle arrangement direction of the ink discharging head 101, and FIG. 5 is a diagram illustrating a cross section along the direction (latitudinal direction of liquid chamber) of the nozzle arrangement of the ink discharging head 101.

The ink discharging head 101 includes a flow path plate (also referred to as liquid chamber substrate, flow path member) 1, a diaphragm 2 jointed onto the bottom surface of the flow path plate 1, and a nozzle plate 3 as the nozzle forming member joined with the top surface of the floe path plate 1. The receding contact angle of the clear ink against the surface of the nozzle plate 3 facing a substrate is 35 degrees or greater.

The ink discharging head 101 is formed of liquid chambers 6 serving as individual paths communicating with nozzles 4 to discharge droplets (droplets of liquid) via a nozzle communicating path 5, a fluid resistance 7 doubled as a supplying path through which the ink is supplied to the individual liquid chamber 6, and a communicating unit 8 communicating with the individual liquid chambers 6 via the fluid resistance 7. The ink is supplied to the communicating unit 8 from a common liquid chamber 10 formed on a frame member 17 via a supply opening 19 formed on the diaphragm 2. The liquid chambers 6 are also referred to as pressurizing liquid chamber, pressure chamber, or flow path.

Openings such as the nozzle communication path 5, the liquid chambers 6, and the fluid resistance 7 are formed on the flow path plate 1 by etching a silicone substrate.

The flow path plate 1 can also be formed by, for example, etching a SUS substrate using an acidic etching solution or mechanical processing such as punching (pressing).

The diaphragm 2 has a vibration region (diaphragm portion) 2a forming the wall of the corresponding liquid chamber 6. The diaphragm 2 has an island convex portion 2b on the outer surface if the vibration region 2a, which is the opposite to the liquid chamber 6. The island convex portion 2b deforms the vibration region 2a to join a laminate piezoelectric element 12 (i.e., actuator, pressure generator) to generate energy for discharging droplets and upper surfaces (joined surfaces) of each of piezoelectric element columns 12A and 12B for the piezoelectric element 12. The lower end surface of the laminate piezoelectric element 12 is joined to a base member 13.

The piezoelectric member 12 is formed by alternately stacking a piezoelectric layer 21 such as PZT and inside electrodes 22A and 22B. The inside electrodes 22a and 22b are drawn out to the side which is substantially perpendicular to the diaphragm 2 of the piezoelectric element 12. The piezoelectric element 12 is connected to side surface electrodes (exterior electrodes) 23a and 23b formed on the side substantially perpendicular to the diaphragm 2 of the piezoelectric element 12 and applies a voltage to the side surface electrodes 23a and 23b to cause displacement along the stacking direction.

The piezoelectric element 12 is subjected to groove processing by half cut dicing to form a required number of piezoelectric element columns 12A and 12B for one piezoelectric element member.

Although the piezoelectric element columns 12A and 12B of the piezoelectric element 12 are the same, they are distinguished from each other in that a drive waveform is applied to drive the piezoelectric element column 12A while a drive waveform is not applied to the piezoelectric element column 12B, which is used as a simple support.

This configuration can be applied to a bi-pitch configuration alternatively using the piezoelectric element column 12A for drive and the piezoelectric element column 12B for support or a normal pitch configuration using all the piezoelectric element columns as the piezoelectric element column 12A.

The piezoelectric element columns 12A and 12B of the piezoelectric element 12 are arranged in two rows of the driving elements (rows of the piezoelectric element columns 12A for drive) in which a plurality of driving piezoelectric element columns 12A for drive are arranged as drive elements on the base member 13.

The piezoelectric direction of the laminate type piezoelectric element 12 applies a pressure to the ink in the liquid chamber 6 utilizing the displacement along the d33 direction (lamination direction of the piezoelectric element material layer). Also, the piezoelectric direction of the laminate type piezoelectric element 12 applies a pressure to the ink in the liquid chamber 6 utilizing the displacement along the d31 direction (the surface direction of the piezoelectric material layer: direction perpendicular to electric field).

The material of the piezoelectric element is not particularly limited. Examples include, but are not limited to, electromechanical conversion elements such as ferroelectric materials including BaTiO₃, PbTiO₃, and (NaK)NbO₃ used as generally used piezoelectric element materials.

Further, although the laminated piezoelectric element is used, a single-plate piezoelectric element may be used.

As the single-plate piezoelectric element, a cut piezoelectric element, a thick-film element obtained by screen printing followed by sintering, or a thin-film element formed by sputtering, vapor deposition, or a sol-gel method can be used.

The laminated piezoelectric elements 12 provided on one base member 13 may have a single row structure or a multiple row structure.

An FPC 15 as a wiring device is directly connected to the external electrode 23a of the piezoelectric element column 12A of the piezoelectric element 12 with solder to provide drive signals. A drive circuit (driver IC) 16 is mounted to the FPC 15 to selectively apply a drive waveform to the piezoelectric element column 12A of the piezoelectric element 12.

The external electrodes 23b of all the piezoelectric element columns 12A are electrically connected and similarly connected to the common wiring of the FPC 15 by a solder member.

Further, the output terminal portion jointed to the piezoelectric element 12 of the FPC 15 is plated with solder, thereby enabling the solder joint. It is also possible to solder plate not on the FPC but on the piezoelectric element 12.

In addition, as for the joining method, it is possible to utilize jointing by an anisotropic conductive film or wire bonding in addition to the soldering

The nozzle plate 3 has an ink repellent film (or water repellent film) 32 formed on a liquid droplet discharging side (surface along the discharging direction, discharging surface or the opposite surface relative to the liquid chamber 6, nozzle forming surface) of the nozzle substrate 31 on which holes constituting the nozzle 4 having a diameter of from 10 to 35 μm corresponding to each liquid chamber 6.

In addition, a frame 17 formed of an epoxy resin or polyphenylene sulfide by injection molding is jointed on the outer peripheral side of a piezoelectric actuator unit 100 including the piezoelectric element 12 on which the FPC 15 is mounted (connected) and the base member 13.

The frame 17 forms the common liquid chamber 10 and the supply opening 19 to supply ink to the common liquid chamber 10 from outside. This supply 19 is connected to an ink supply source such as a sub-tank and an ink container.

In the liquid discharging head having such a configuration, the piezoelectric element 12A shrinks by lowering the voltage applied to the piezoelectric element 121 from the reference voltage. The vibration region 2a of the diaphragm 2 is lowered, thereby inflating the volume of the liquid chamber 6 so that the ink flows into the liquid chamber 6. Thereafter, the voltage to be applied to the piezoelectric element 12A is raised to elongate the piezoelectric element column 12A along the stacking direction. The diaphragm 2 is deformed along the nozzle 4 to shrink the column of the liquid chamber 6, thereby applying a pressure to the ink in the liquid chamber 6 so that the liquid droplet of the ink is discharged (jetted) from the nozzle 4.

Thereafter, when the voltage applied to the piezoelectric element column 12A is returned to the reference voltage, the diaphragm 2 is back to the initial position so that the liquid chamber 6 inflates, generating a negative pressure. At this time, the liquid chamber 6 is filled with the ink from the common liquid chamber 10.

After the vibration of the meniscus surface of the nozzle 4 decays and becomes stable, the system starts operations to discharge the next droplet.

The drive method of the ink discharging head is not limited to the above-mentioned (pull—push discharging). The way of discharging changes in accordance with how a drive waveform is provided, and pull discharging or push discharging is possible.

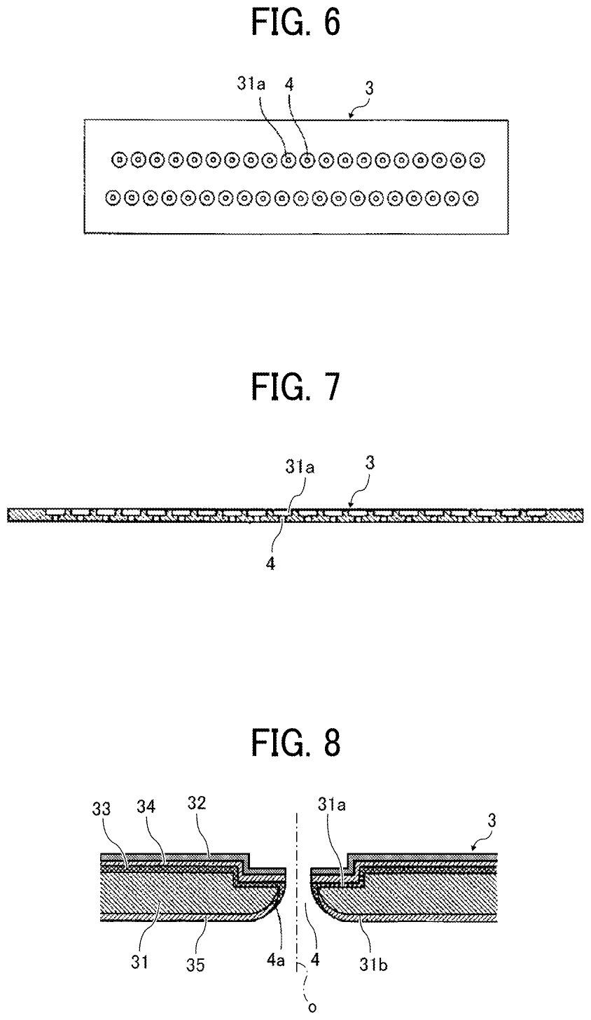

The nozzle plate 3 in the inkjet printing device of the present disclosure is described with reference to FIG. 6 to FIG. 8. FIG. 6 is a diagram illustrating a planar view of the nozzle plate 3, FIG. 7 is a diagram illustrating a cross section thereof, and FIG. 8 is a diagram illustrating an enlarged cross section of a single nozzle portion.

The nozzle plate 3 includes a Ti layer 33 as a base layer, an SiO₂ film 34, and a perfluoropolyether film (referred to as a water repellent film) 32 having alkoxysilane in the molecule are formed on a discharging surface 31a of the nozzle substrate 31 made of Ni metal plate in this order from the surface of the nozzle substrate 31.

The surface of the nozzle plate 3 except the nozzle 4 and the receding contact angle of clear ink against the surface opposing a substrate is 35 degrees or greater.

In the vicinity of the exit of the inner wall surface 4a of the nozzle 4, the base layer (Ti layer) 33 is continuously formed from the discharging surface on the SiO₂ film 35 formed on the liquid chamber surface 31b of the nozzle substrate 31. The base layer (Ti layer) 33 is exposed to the outermost surface.

The nozzle substrate 31 can be formed of Ni metal plate but is not limited thereto.

Here, the water repellent film 32 of the nozzle plate 3 is formed by vapor deposition and a vapor-deposited film for forming the water repellent film 32 is not formed near the exit of the inner wall surface of the nozzle 4.

This makes it possible for the nozzle plate 3 to stably discharge droplets without causing discharging failure or impairing liquid filling property.

The receding contact angle of the ink against the nozzle plate is 35 degrees or greater, preferably from 35 to 80 degrees, and more preferably from 40 to 70 degrees.

Even if the clear ink adheres to the wall surface of the ink chamber of an ink discharging head, it is easy to repel the clear ink again when the receding contact angle is 35 degrees or greater. Incidentally, the upper limit of the receding contact angle is not particularly limited because as the receding contact angle increases, the nozzle plate does not become wet. To enhance permeability to a recording medium, the receding contact angle does not preferably surpass 80 degrees.

The receding contact angle can be measured by, for example, an automatic contact angle measuring device and an expansion/contraction method. An example of the automatic contact angle measuring device is DMo-501 (manufactured by Kyowa Interface Science Co., Ltd.).

For example, 3 μl of clear ink is extruded from a syringe to the exterior surface of the nozzle plate for use in the present disclosure to measure the receding contact angle by the device mentioned above by the contraction method. The receding contact angle in the present disclosure means a value at a measurement temperature of 25 degrees C.

Ink Container

The ink container accommodates ink.

The ink container is not particularly limited as long as it is a member capable of accommodating ink. For example, it includes an ink storage container and an ink tank.

The ink container accommodates the ink and includes other optional suitably-selected members.

There is no specific limit to the ink container. It is possible to select any form, any structure, any size, and any material. For example, a container having at least an ink bag formed of aluminum laminate film, a resin film, etc. can be suitably used.

The ink tank includes a main tank and a sub-tank.

Heating Device

The heating device heats a substrate.

The heating device dries the printing surface and the rear side of the recording medium as the substrate by heating and examples include, but are not limited to, an infrared heater, a heated wind heater, and a heating roller. These can be used alone or in combination.

The method of drying the recording medium as the substrate is not particularly limited and can be suitably selected to suit to a particular application. Examples include, but are not limited to, a method of bringing a heated fluid such as heated wind as a drying medium into contact with the recording medium to which the ink is applied, a method of drying the recording medium with heat transferred by bringing the heating member into contact with the recording medium to which the ink is applied, and a method of heating the recording medium to which the ink is applied by irradiating it with energy rays such as infra red and far infrared.

The recording medium can be heated before, during, or after printing.

When the recording medium is heated before or during printing, the ink is applied to the recording medium already heated. When the recording medium is heated after printing, a print product can be dried.

The heating time is not particularly limited as long as the temperature of the surface of the recording medium can be desirably controlled and can be suitably set to suit to a particular application

It is preferable to control the time length of heating by controlling conveyance speed of the recording medium as printed matter and a print product.

The temperature HTₘₐₜₜₑ (degrees C.) of the heating device for the printing region in the low gloss printing mode is preferably 50 or higher degrees C., more preferably from 50 to 80 degrees C., and furthermore preferably from 65 to 70 degrees C.

The temperature HT_{gloss} (degrees C.) of the heating device for the printing region in the high gloss printing mode is preferably 70 degrees C. or lower, more preferably 60 degrees C. or lower, furthermore preferably from 40 to 60 degrees C., and particularly preferably from 50 to 60 degrees C.

Ink

Clear ink is used as the ink.

The clear ink is colorless and transparent containing no coloring material.

The clear ink contains water as solvent and may further optionally contain an organic solvent.

The aqueous clear ink contains water, a resin, preferably a surfactant, and other optional components.

Water

There is no specific limitation to the water and it can be suitably selected to suit to a particular application. For example, deionized water, ultrafiltered water, reverse osmosis water, pure water such as distilled water, and ultra pure water are suitable. These can be used alone or in combination.

The proportion of the water is preferably from 15 to 60 percent by mass of the total content of the clear aqueous ink. When the proportion is 15 or greater percent by mass, the clear ink can be prevented from being thickened, thereby enhancing discharging stability. When the proportion is 60 or less percent by mass, wettability to a non-permeable recording medium is enhanced, thereby enhancing image quality.

Resin

The resin has no particular limit and can be suitably selected to suit to a particular application. Specific examples include, but are not limited to, polyurethane resins, polyester resins, acrylic resins, vinyl acetate resins, styrene resins, butadiene resins, styrene-butadiene resins, vinylchloride resins, acrylic styrene resins, and acrylic silicone resins.

When manufacturing the ink, it is preferable to add the resin as resin particles composed of these resins. The resin particle may be added to the ink in a form of a resin emulsion in which the resin is dispersed in water as a dispersion medium. It is possible to use suitably-synthesized resin particles as the resin particle. Alternatively, the resin particle available on the market can be used. These resin particles can be used alone or in combination. Of these, polyurethane resins are preferable as the resin mentioned above. When a polyurethane resin is present in an ink film formed with the clear ink, the film itself becomes tough. This is preferable because it is possible to prevent the inside of the film from being broken and partially peeled or the surface state of the film from changing, thereby changing the color of abraded portions.

Polyurethane Resin

Examples of the polyurethane resin include, but are not limited to, polyether-based polyurethane resins, polycarbonate-based polyurethane resins, and polyester-based polyurethane resins.

The polyurethane resin is not particularly limited and can be suitably selected to suit to a particular application. An example is a polyurethane resin produced by reaction between polyol and polyisocyanate.

Polyol

Examples of the polyol include, but are not limited to, polyether polyols, polycarbonate polyols, and polyester polyols. These can be used alone or in combination.

Polyether Polyol

An example of the polyether polyol can be obtained by subjecting at least one compound having two or more active hydrogen atoms as a starting material to addition polymerization with alkylene oxide.

Specific examples of the compound having two or more active hydrogen atoms include, but are not limited to, ethylene glycol, diethylene glycol, triethylene glycol, propylene glycol, trimethylene glycol, 1,3-butanediol, 1,4-butanediol, 1,6-hexane diol, glycerin, trimethylolethane, and trimethylol propane. These can be used alone or in combination.

Specific examples of the alkylene oxide include, but are not limited to, ethylene oxide, propylene oxide, butylene oxide, styrene oxide, epichlorohydrin, and tetrahydrofuran. These can be used alone or in combination.

The polyether polyol is not particularly limited and can be suitably selected to suit to a particular application. Polyoxytetra methylene glycol and polyoxypropylene glycol are preferable to obtain a binder for ink that can impart extremely excellent abrasion resistance. These can be used alone or in combination.

Polycarbonate Polyol

Examples of the polycarbonate polyol that can be used in the production of the polyurethane resin include, but are not limited to, a product obtained by reacting a carboxylic acid ester with a polyol or a product obtained by allowing to react phosgene with bisphenol A. These can be used alone or in combination.

Specific examples of the carboxylic acid include, but are not limited to, methyl carbonate, dimethyl carbonate, ethyl carbonate, diethyl carbonate, cyclocarbonate, an diphenyl carbonate. These can be used alone or in combination.

Specific examples of the polyol include, but are not limited to, relatively low molecular weight dihydroxy compounds such as ethylene glycol, diethylene glycol, triethylene glycol, 1,2-propylene glycol, 1,3-propylene glycol, dipropylene glycol, 1,4-butanediol, 1,3-butanediol, 1, 2-butanediol, 2,3-butanediol, 1,5-pentanediol, 1,5-hexanediol, 2,5-hexanediol, 1,6-hexanediol, 1,7-heptanediol, 1,8-octanediol, 1,9-nonanediol, 1,10-decanediol, 1,11-undecanediol, 1,12-dodecanediol, 1,4-cyclohexanediol, 1,4-cyclohexane dimethanol, hydroquinone, resorcinol, bisphenol-A, bisphenol F, and 4,4′-biphenol; polyether polyol such as polyethylene glycol, polypropylene glycol, and polyoxytetramethylene glycol; and polyester such as polyhexamethylene adipate, polyhexamethylene succinate, and caprolactone.

These can be used alone or in combination.

Polyester Polyol

Specific examples of the polyester polyol include, but are not limited to, a product obtained by esterification reaction between a low molecular weight polyol and a polycarboxylic acid, a polyester obtained by a ring-opening polymerization reaction of a cyclic ester compound such as ε-caprolactone, and a coploymerized polyester. These can be used alone or in combination.

Specific examples of the low molecular weight polyol include, but are not limited to, ethylene glycol and propylene glycol. These can be used alone or in combination.

Specific examples of the polycarboxylic acid include, but are not limited to, succinic acid, adipic acid, sebacic acid, dodecane dicarboxylic acid, terephthalic acid, isophthalic acid, phthalic acid, and anhydrides or ester forming derivatives thereof. These can be used alone or in combination.

Polyisocyanate

Specific examples of the polyisocyanate include, but are not limited to, aromatic diisocyanates such as phenylene diisocyanate, tolylene diisocyanate, diphenylmethane diisocyanate, and naphthalene diisocyanate, and aliphatic or alicyclic diisocyanates such as hexamethylene diisocyanate, lysine diisocyanate, cyclohexane diisocyanate, isophorone diisocyanate, dicyclohexylmethane diisocyanate, xylylene diisocyanate, tetramethylxylylene isocyanate, and 2,2,4-trimethylhexamethylene diisocyanate. These can be used alone or in combination.

Of these, alicyclic diisocyanate is preferable as the polyisocyanate to enhance weatherability.

Furthermore, it is preferable to add at least one type of alicyclic diisocyanates, thereby easily imparting a desired film toughness and abrasion resistance.

Specific examples of the alicyclic diisocyanate include, but are not limited to, isophorone diisocyanate and dicyclohexylmethane diisocyanate.

The proportion of the alicyclic diisocyanate is preferably 60 percent by mass or greater to the total content of the isocyanate compound.

Method of Manufacturing Polyurethane Resin

The polyurethane resin can be manufactured by conventional manufacturing methods without a particular limitation. The following method is suitably used.

First, an isocyanate-terminated urethane prepolymer is prepared in the presence of an organic solvent or the absence of a solvent by the reaction of the polyol and the polyisocyanate with an equivalent ratio in which isocyanate groups are excessive.

Next, optionally the anionic group in the isocyanate-terminated urethane prepolymer is neutralized by a neutralizer. Subsequent to reaction with a chain elongating agent, the system is optionally purged of the organic solvent to obtain the urethane resin.

Specific examples of the organic solvent usable for the production of the polyurethane resin include, but are not limited to, ketones such as acetone and methylethyl ketone, ethers such as tetrahydrofuran and dioxane, acetic acid esters such as ethyl acetate and butyl acetate, nitriles such as acetonitrile, and amides such as dimethyl formamide, N-methyl pyrrolidone, and N-ethyl pyrrolidone.

These can be used alone or in combination.

Polyamines or other compounds containing an active hydrogen group can be used as the chain elongating agent.

Specific examples of the polyamine include, but are not limited to, diamines such as ethylene diamine, 1,2-propane diamine, 1,6-hexamethylene diamine, piperazine, 2,5-dimethyl piperazine, isophorone diamine, 4,4′-dicyclohexyl methane diamine, and 1,4-cyclohexane diamine, polyamines such as diethylene triamine, dipropylene triamine, and triethylene tetramine, hydrazines, hydrazines such as N,N′dimethyl hydrazine and 1,6-hexamethylene bis hydrazine, and dihydrazides such as succinic dihydrazide, adipic acid dihydrazide, glutaric acid dihydrazide, sebacic acid dihydrazide, and isophthalic acid dihydrazide. These can be used alone or in combination.

Specific examples of the other compounds having active hydrogen groups include, but are not limited to, glycols such as ethylene glycol, diethylene glycol, triethylene glycol, propylene glycol, 1,3-propane diol, 1,3-butane diol, 1,4-butane diol, hexamethylene glycol, saccharose, methylene glycol, glycerin, and sorbitol, phenols such as bisphenol A, 4,4′-dihydroxydiphenyl, 4,4′-dihydroxydiphenyl ether, 4,4′-dihydroxydiphenyl sulfone, hydrogenated bisphenol A, and hydroquinone, and water. These can be used alone or in combination unless the storage stability of the ink is degraded.

As the polyurethane resin, polycarbonate-based polyurethane resins are preferable in terms of water resistance, heat resistance, abrasion resistance, weather resistance, and friction resistance of an image due to high agglomeration power of carbonate groups. When the ink contains a polycarbonate-based polyurethane resin, it is suitable for recorded matter for use in severe conditions like outdoor use.

As the polyurethane resin, products available on the market can be used. Specific examples include, but are not limited to, UCOAT UX-485 (polycarbonate-based polyurethane resin), UCOAT UWS-145 (polyester-based polyurethane resin), PERMARIN UA-368T (polycarbonate-based polyurethane resin), and PERMARIN UA-200 (polyether-based polyurethane resin) (all manufactured by Sanyo Chemical Industries, Ltd.). These can be used alone or in combination.

The proportion of the resin in the clear ink is preferably from 8 percent by mass or more and more preferably from 8 to 25 percent by mass. When the proportion of the resin is eight or greater percent by mass, low gloss and high gloss can be controlled with a small amount of clear ink. Conversely, when the proportion of the resin surpasses 25 percent by mass, discharging stability of the ink may deteriorate.

Low gloss is demonstrated by forming isolated dots having high dot ball height (pile height) to impart roughness to the surface.

When the proportion of the resin in the clear ink is large, dots having a high pile height are easily formed, which is preferable in terms of imparting low gloss.

Conversely, high gloss is obtained by filling surface irregularities with clear ink, thereby forming a smooth surface. In order to fill the surface irregularities with the clear ink, it is preferable that the proportion of the resin in the clear ink be large because the surface irregularities can be filled with a small amount of clear ink, thereby easily imparting high gloss.

Surfactant

The clear ink preferably contains a surfactant.

It is preferable that the surfactant lower the surface tension of the ink when added to the ink and be not decomposed on a recording medium such as paper in a form of ink droplet or in a high pH environment.

Specific examples of the silicone-based surfactant include, but are not limited to, side-chain modified polydimethyl siloxane, both-terminal modified polydimethyl siloxane, one-terminal-modified polydimethyl siloxane, and side chain both-terminal modified polydimethyl siloxane. Silicone-based surfactants having a polyoxyethylene group or polyoxyethylene polyoxypropylene group as the modification group are particularly preferable because these demonstrate good properties as aqueous surfactants. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination or two or more thereof.

Using a polyether-modified siloxane compound is preferable as a surfactant. Inclusion of the polyether-modified siloxane compound as the surfactant in clear ink makes the ink not easy to be wet on the ink repelling film of the nozzle plate of a head. Therefore, defective discharging caused by ink attached to a nozzle can be prevented to improve discharging stability. Inclusion of the polyether-modified siloxane compound as the surfactant in clear ink prevents defective discharging caused by such a problem that the ink is not readily attached to the layer surface of a nozzle ink repellent film.

Of these, it is preferable to select surfactants represented by the following Chemical Formula V to Chemical Formula VIII. In particular, surfactants having a low dynamic surface tension, a high permeability, and an excellent leveling property without degrading dispersion stability irrespective of the type of the water-dispersible colorant and the combination with an organic solvent.

These surfactants can be used alone or in combination.

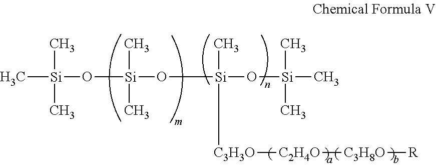

In Chemical Formula V, R represents a hydrogen atom and an alkyl group having 1 to 4 carbon atoms. m represents zero or an integer of from 1 to 23, n represents an integer of from 1 to 10, a represents an integer of from 1 to 23, and b represents zero or an integer of from 1 to 23.

Examples of the compound represented by the Chemical Formula V include, but are not limited to, compounds represented by the following Chemical Formula 7 to 14.

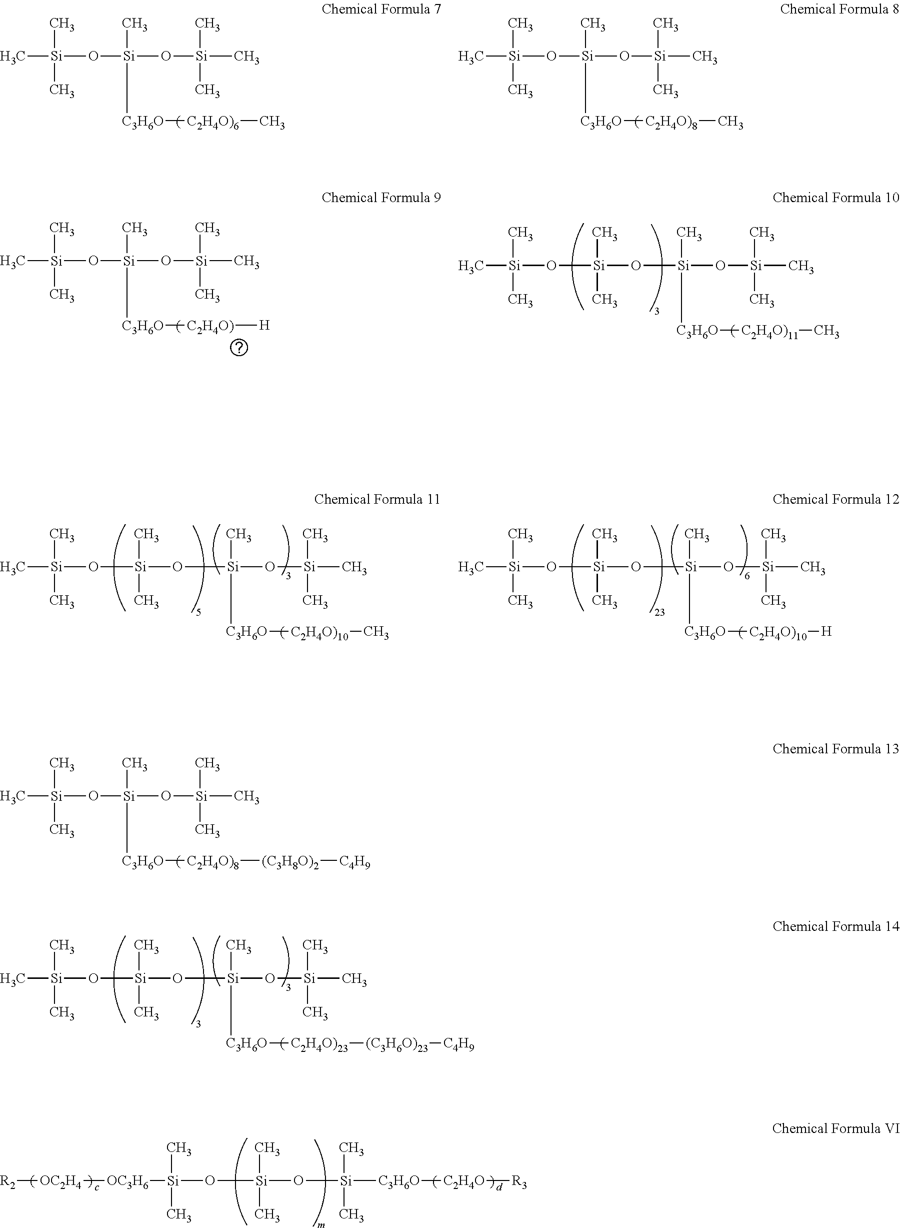

R₂ an R₃ each, independently represent hydrogen atoms or alkyl groups having 1 to 4 carbon atoms. m represents an integer of from 1 to 8 and c and d each, independently represent integers of from 1 to 10.

Examples of the compound represented by the Chemical Formula VI are compounds represented by the following Chemical Formula 15.

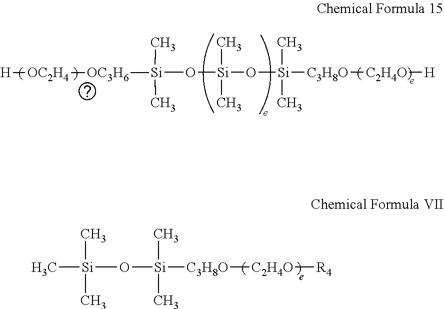

In Chemical Formula VII, R₄ represents a hydrogen atom or alkyl group having 1 to 4 carbon atoms. e represents an integer of from 1 to 8.

Examples of the compound represented by the Chemical Formula VII are compounds represented by the following chemical structure 16.

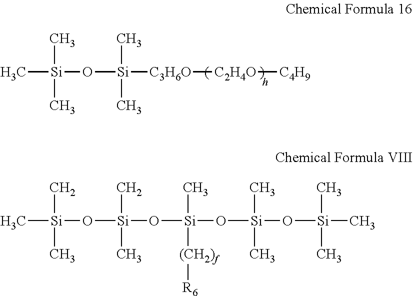

In Chemical Formula VIII, R₅ represents a polyether group or the following Chemical Formula A. f represents an integer of from 1 to 8.

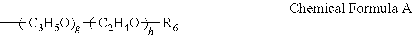

In Chemical Formula A, R₆ represents a hydrogen atom or alkyl group having 1 to 4 carbon atoms. g represents zero and an integer of from 1 to 23, and h represents zero and an integer of from 1 to 23, excluding the case in which g and h are simultaneously 0.

Examples of the compound represented by the Chemical Formula VIII are compounds represented by the following Chemical Formulae 17 to 19.

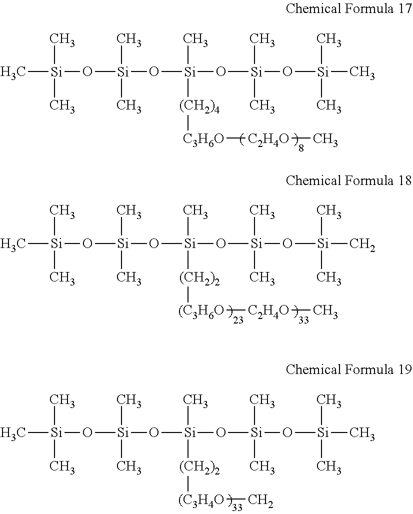

Furthermore, specific examples of polyether-modified siloxane compound surfactants commercially available demonstrating the same feature as the above-mentioned compound include, but are not limited to, 71ADDITIVE, 74ADDITIVE, 57ADDITIVE, 8029ADDITIVE, 8054ADDITIVE, 8211ADDITIVE, 8019ADDITIVE, 8526ADDITIVE, and FZ-2123, FZ-2191, all manufactured by Dow Corning Toray Co., Ltd., TSF4440, TSF4441, TSF4445, 10 TSF4446, TSF4450, TSF4452, and TSF4460, all manufactured by Momentive Performance Materials Inc., SILFACE SAG002, SILFACE SAG003, SILFACE SAG005, SILFACE SAG503A, SILFACE SAG008, and SILFACE SJM0063, all manufactured by Nisshin Chemical Co., Ltd., TEGO_Wet_KL245, TEGO_Wet_250, TEGO_Wet_260, TEGO_Wet_265, TEGO_Wet 270, and TEGO_Wet 280, all manufactured by Evonik Industries AG, and BYK-345, BYK-347, BYK-348, BYK-375, and BYK-377, all manufactured by BYK Japan KK.

In addition, the polyether-modified siloxane compound surfactant, fluorochemical surfactants, silicone-based surfactants, and acetyleneglycol-based or acetylenealcohol-based surfactants can be used in combination.

The proportion of the surfactant in ink is preferably 5 percent by mass or less and more preferably from 0.5 to 3 percent by mass. The proportion of 3 percent by mass or less enhances the effect of addition of a surfactant. When the proportion is greater than 3 percent by mass, the addition effect is saturated, meaning that increasing the proportion furthermore is meaningless.

Organic Solvent

The clear ink may contain an organic solvent. The organic solvent has no specific limit and is suitably selected to suit to a particular application. For example, water-soluble organic solvents are usable. One of the definitions of “water soluble” is that 5 or more grams are dissolved in 100 g of water at 25 degrees C.

Specific examples of the water-soluble organic solvent include, but are not limited to, polyols such as ethylene glycol, diethylene glycol, 1,2-propane diol, 1,3-propane diol, 1,2-butane diol, 1,3-butane diol, 2,3-butane diol, 3-methyl-1,3-butane diol, 3-methoxy-3-methylbutanol, triethylene glycol, polyethylene glycol, polypropylene glycol, 1,5-pentane diol, 2-methyl-2,4-pentane diol, 1,6-hexane diol, glycerin, 1,2,6-hexane triol, 2-ethyl-1,3-hexane diol, ethyl-1,2,4-butane triol, 1,2,3-butane triol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, propylene glycol monoethyl ether, and dipropylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone; amides such as formamide, N-methylformamide, and N,N-dimethylformamide; amines such as monoethanolamine, diethanolamine, and triethanolamine; sulfur-containing compounds such as dimethyl sulfoxide, sulfolane, and thiodiethanol; propylene carbonate, and ethylene carbonate. These can be used alone or in combination.

The proportion of the organic solvent in the clear ink has no particular limit and can be suitably selected to suit to a particular application.

In terms of drying and discharging reliability of ink, the proportion is preferably from 10 to 60 percent by mass and more preferably from 20 to 60 percent by mass.

The clear ink may furthermore optionally contain, for example, a defoaming agent, a preservatives and fungicides, a corrosion inhibitor, and a pH regulator.

Defoaming Agent

The defoaming agent has no particular limit and examples include, but are not limited to silicon-based defoaming agents, polyether-based defoaming agents, and aliphatic acid ester-based defoaming agents. These can be used alone or in combination. Of these, silicone-based defoaming agents are preferable to achieve the effect of foam breaking.

Preservatives and Fungicides

The preservatives and fungicides are not particularly limited. One specific example is 1,2-benzisothiazoline-3-one.

Corrosion Inhibitor

The corrosion inhibitor has no particular limitation. Examples are acid sulfites and sodium thiosulfates.

pH Regulator

The pH regulator has no particular limit as long as it can control pH to not lower than 7. Specific examples include, but are not limited to, amines such as diethanol amine and triethanol amine.

Properties of the clear ink are not particularly limited and can be suitably selected to suit to a particular application. Properties such as viscosity, surface tension, and pH are preferably in the following ranges.

Viscosity of the clear ink at 25 degrees C. is preferably from 5 to 30 mPa·s and more preferably from 5 to 25 mPa·s to improve print density and text quality and obtain good dischargeability. Viscosity can be measured by an instrument such as a rotatory viscometer (RE-80L, manufactured by TOKI SANGYO CO., LTD.). The measuring conditions of the viscosity are as follows:
Standard cone rotor (1°34′×R24)
Sample liquid amount: 1.2 mL
Number of rotations: 50 rotations per minute (rpm)
25 degrees C.
Measuring time: three minutes.

The surface tension of the clear ink is preferably 35 or less mN/m and more preferably 32 or less mN/m at 25 degrees C. in terms of suitable leveling of the ink on a recording medium and quickly drying the ink.

pH of the clear ink is preferably from 7 to 12 and more preferably from 8 to 11 in terms of prevention of corrosion of metal material in contact with liquid.

Substrate

The substrate is not limited to items used as recording media and includes building materials such as wall paper, floor material, and tiles, cloth for apparel such as T-shirts, textile, and leather. The substrate may include a printed layer formed with ink containing a coloring material before the clear ink is applied to the substrate. In addition, substances such as ceramics, glass, and metal can be used as the substrate if the configuration of the paths through which the recording medium is conveyed is adjusted.

The recording medium is not particularly limited. Materials such as plain paper, gloss paper, special paper, and cloth are usable. Also, good images can be formed on a non-permeable substrate.

The non-permeable substrate has a surface with low moisture permeability, and absorbency and includes a material having many hollow spaces inside that are not open to the outside. The non-permeating substrate has a water-absorbency of 10 mL/m² or less between the initiation of contact and 30 msec¹² later according to Bristow's method.

Specific examples of the non-permeable substrate include, but are not limited to plastic films such as polyvinyl chloride resin film, polyethylene terephthalate (PET) film, acrylic resin film, polypropylene film, polyethylene film, and polycarbonate film.

In the present disclosure, it is preferable to use a substrate having high gloss in the low gloss printing mode. This is because the low gloss effect by the clear ink tends to be emphasized in the case of a substrate having high gloss.

In the present disclosure, it is preferable to use a substrate having low gloss in the high gloss printing mode. This is because the high gloss effect by the clear ink tends to be emphasized in the case of a substrate having low gloss.

Therefore, when the degree of gloss of the substrate to be used in the low gloss printing mode is Gₘₐₜₜₑ and the degree of gloss of the substrate to be used in the high gloss printing mode is G_{gloss}, the following relationship is satisfied: Gₘₐₜₜₑ>G_{gloss}, and preferably Gₘₐₜₜₑ−G_{gloss}≥100.

Method of Controlling Gloss of Printed Image

The gloss of a printed image is controlled by a method including discharging a clear ink containing a resin and water from an ink discharging head to a substrate to form a printing layer, heating the substrate on which the printing layer has been formed, wherein the method has a first printing mode and a second printing mode, wherein the following relationship is satisfied: Tₘₐₜₜₑ degrees C.>T_{gloss} degrees C., where Tₘₐₜₜₑ represents the temperature of the substrate in the heating in the printing portion printed in the first printing mode in which the clear ink is discharged and attached and T_{gloss} represents the temperature of the substrate in the heating in the printing portion printed in the second printing mode in which the clear ink is discharged and attached, wherein the receding contact angle of the clear ink against the nozzle plate of the ink discharging head is 35 degrees or greater.

The first printing mode is to apply low gloss and also referred to as low gloss printing mode. The second printing mode is to apply high gloss and also referred to as high gloss printing mode.

Print Product

The print product for use in the present disclosure includes a substrate and a printing layer formed on the substrate. The printing layer includes a clear ink layer containing a resin. The print product has a first print image printed in the first printing mode and/or a second print image printed in the second printing mode. The 60 degree gloss Ga of the first print image and the 60 degree gloss Gb of the substrate for use in the second printing mode satisfy the following relationship: Ga−Gb≥20. The 60 degree gloss Gc of the first print image and the 60 degree gloss Gd of the substrate for use in the first printing mode satisfy the following relationship: Gc−Gd≤−20.

The first printing mode is to apply low gloss and also referred to as low gloss printing mode. The second printing mode is to apply high gloss and also referred to as high gloss printing mode.

The print product can be formed as a high gloss image and a low gloss image with a single inkjet printing device and the gloss difference between both is Gc−Gd≤−20.

The print product can be obtained by forming images by the inkjet printing device executing the inkjet printing method.

Recording Device and Recording Method

Hereinafter, an example in which black (K), cyan (C), magenta (M), and yellow (Y) are used in the description of the following recording device and the following recording method. It is possible to use the clear ink in place of or in addition to those inks.

The clear ink for use in the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices (3D printers, additive manufacturing devices).

In addition, the inkjet printing device includes both a serial type device in which the liquid discharging head moves and a line type device in which the liquid discharging head is not moved, unless otherwise specified.

Furthermore, in addition to the desktop type, this inkjet recording device includes a recording device capable of print images on a wide recording medium such as AG and a continuous printer capable of using continuous paper reeled up in a roll form as recording media.

In the present disclosure, the recording (printing) device and the recording (printing) method respectively represent a device capable of discharging ink and liquids such as various processing liquids to a recording medium and a method of recording utilizing such a device. The method includes applying the ink of the present disclosure to a recording medium (a print substrate) preferably with a discharging head. The print substrate includes a low-polarity recording medium. The recording medium means an item to which ink or various processing fluids can be attached even temporarily.

The recording device may further optionally include a device relating to feeding, conveying, and ejecting a recording medium and other devices referred to as a pre-processing device, a post-processing device in addition to the head portion to discharge the ink.

In addition, the recording device and the print method are not limited to those producing meaningful visible images such as text and figures with the ink. For example, the recording method and the recording device capable of producing patterns like geometric design and 3D images are included.

In addition, the recording device includes both a serial type device in which the discharging head moves and a line type device in which the discharging head is not moved, unless otherwise specified.

Furthermore, in addition to the desktop type, this recording device includes a device capable of print images on a wide recording medium such as A0 and a continuous printer capable of using continuous paper reeled up in a roll form as recording media.

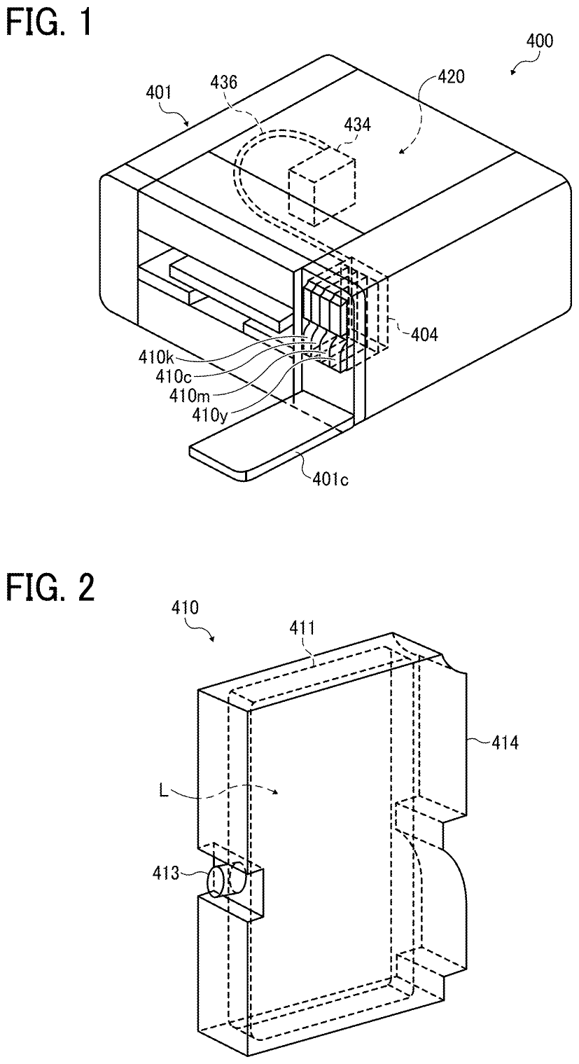

The inkjet printing device is described using an example with reference to FIG. 1 and FIG. 2. FIG. 1 is a diagram illustrating a perspective view of the printing device. FIG. 2 is a diagram illustrating a perspective view of a tank. An image forming device 400, which is an embodiment of the recording device, is a serial type image forming device. A mechanical assembly 420 is disposed in an exterior 401 of the image forming device 400. Each ink containing unit 411 of each tank 410 (410k, 410c, 410m, and 410y) for each color of black (K), cyan (C), magenta (M), and yellow (Y) is made of a packaging member such as aluminum laminate film. The ink containing unit 411 is housed in, for example, a plastic container housing unit 414 and L represents liquid contained in the ink containing unit 411. Due to this configuration, the tank 410 is used as an ink cartridge for each color.

A cartridge holder 404 is disposed on the rear side of the opening formed when a cover 401c is opened. The tank 410 is detachably attached to the cartridge holder 404. In this configuration, each ink discharging outlet 413 of the tank 410 communicates with a discharging head 434 for each color via a supplying tube 436 for each color so that the image forming device 400 can discharge the ink from the discharging head 434 to a recording medium.

This recording device may include not only a portion to discharge ink but also a device referred to as a pre-processing device and a post-processing device.

As an example of the pre-processing device and the post-processing device, as in the case of the ink such as black (K), cyan (C), magenta (M), and yellow (Y), the pre-processing device and the post-processing device each may further include a liquid accommodating unit containing a pre-processing fluid or a post-processing fluid to discharge the pre-processing fluid or the post-processing fluid according to an inkjet printing method.

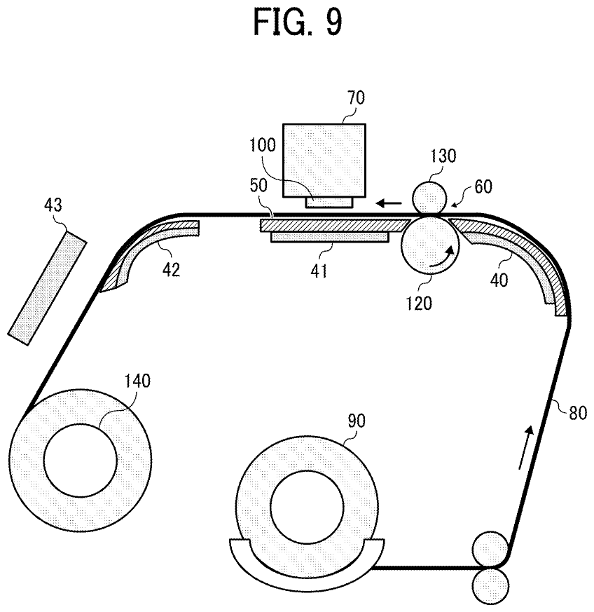

As another example of the pre-processing device and the post-processing device, it is possible to dispose a pre-processing device and a post-processing device which do not employ the inkjet printing method but a blade coating method, a roll coating method, or a spray coating method. FIG. 9 is a diagram illustrating the inside of an inkjet printing device, which includes an ink discharging head 101, a platen 3, a roll media storage unit 4, and heating devices, etc.

A carriage 70 carries the ink discharging head 101 as a discharging device to discharge ink droplets that includes clear ink and other optional color inks such as black (K), yellow (Y), magenta (M), and cyan (C).

The roll medium containing unit feeds a roll medium 90 as printed matter set therein.

A conveyance device 60 includes a conveying roller 120 and a pressing roller 130 facing each other sandwiching the platen 50 from top and bottom.

While a recording medium (substrate) 80 is nipped between the conveying roller 120 and the pressing roller 130, the conveying roller 120 is rotated in the direction indicated by the arrow to convey forward the recording medium 80 conveyed onto the platen 50.

In addition, there are provided a pre-heater 40 that preliminarily heats the recording medium 80, which is disposed upstream of the platen 50 in the recording medium conveying direction and a print heater 41 as the heating device that conducts heating when the clear ink is discharged from the recording head and attached onto the substrate.

Furthermore, on the upstream side of the recording head, a post heater 42 may be provided downstream of the platen 50. Because of the post heater 42, the recording medium 80 can be sequentially heated to promote drying of the reached ink droplets, which is preferable.

For the pre-heater 40, the print heater 41, and the post heater 42, conduction heating heaters using ceramic or nichrome wire, etc. are used.

Moreover, a hot air fun 43 is provided downstream of the starting point of the post heater 42 serving as the second heating process to conduct the third heating process in which the hot air fun 43 blows hot air to the image-printed surface of the recording medium 80 on which the ink droplets are deposited. Hot air is directly blown to the ink on the image-recorded surface by the hot air fun 43 so that the ink is completely dried. Thereafter the recording medium 80 is rolled up by a roll-up roller 140.

Notably, the ink is applicable not only to the inkjet recording but can be widely applied in other methods. Specific examples of such methods other than the inkjet recording include, but are not limited to, blade coating methods, gravure coating methods, bar coating methods, roll coating methods, dip coating methods, curtain coating methods, slide coating methods, die coating methods, and spray coating methods.

The usage of the ink is not particularly limited and can be suitably selected to suit to a particular application. For example, the ink can be used for printed ₘₐₜₜₑr, a paint, a coating material, and foundation. The ink can be used to produce two-dimensional text and images and furthermore used as a material for solid fabrication for manufacturing a solid fabrication object (or solid freeform fabrication object).

The solid fabrication apparatus to fabricate a solid fabrication object can be any known device with no particular limit. For example, the apparatus includes a container, supplying device, discharging device, drier of ink, and others. The solid fabrication object includes an object manufactured by repetitively coating ink. In addition, the solid fabrication object includes a mold-processed product manufactured by processing a structure having a substrate such as a recording medium to which the ink is applied. The molded processed product can be fabricated from recorded matter or a structure having a sheet-like form or film-like form by heating drawing or punching. The molded processed product is suitably used as parts molded after surface-decorating. Examples include, but are not limited to, gauges or operation panels of vehicles, office machines, electric and electronic devices, cameras.

Terms such as image forming, recording, printing, and print used in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. Unless otherwise specified, the inks were prepared and evaluated under the conditions of room temperature of 25 degrees C. and humidity of 60 percent.

### Preparation Example 1

Preparation of Polycarbonate-Based Polyurethane Resin Emulsion 1

A total of 1,500 parts of polycarbonate diol (reaction product of 1,6-hexane diol and dimethyl carbonate, number average molecular weight (Mn) of 1200), 220 parts of 2,2-dimethylol propionic acid (DMPA), and 1,347 parts of N-methyl pyrrolidone (NMP) were charged in a reaction container equipped with a stirrer, a reflux cooling tube, and a thermometer in a nitrogen atmosphere followed by heating to 60 degrees C. to dissolve DMPA. Thereafter, 1,445 parts of 4,4′-dicyclohexyl methane diisocyanate and 2.6 parts of dibutyl tin dilaurylate (catalyst) were added thereto followed by heating to 90 degrees C. to complete urethanation reaction in five hours. As a result, an isocyanate-terminated urethane prepolymer was obtained. This reaction mixture was cooled down to 80 degrees C. and 149 parts of triethyl amine was admixed therewith. A total of 4,340 parts of the resulting mixture was weighed and charged in a liquid mixture of 5,400 parts of water and 15 parts of triethyl amine during vigorous stirring.

Thereafter, 1,500 parts of ice and 626 parts of 2-methyl-1,5-pentane diamine aqueous solution at 35 percent by mass were added to allow chain elongation reaction followed by distillation away of the solvent in such a manner that the solid portion concentration was 30 percent by mass to obtain polycarbonate-based polyurethane resin emulsion 1.

The obtained polycarbonate-based polyurethane resin emulsion was analyzed by a film forming temperature tester (manufactured by IMOTO MACHINERY CO., LTD.). The minimum film-forming temperature was 55 degrees C.

### Preparation Example 2

Preparation of Acrylic Resin Emulsion 1

A total of 900 parts of deionized water and 1 part of sodium lauryl sulfate were charged in a reaction container equipped with a stirrer, a reflux condenser, a dripping device, and a thermometer and heated to 70 degrees C. during nitrogen replacement with stirring. While the temperature inside was maintained at 70 degrees C., 4 parts of potassium persulfate was added as a polymerization initiator and dissolved. An emulsion preliminarily prepared by adding 450 parts of deionized water, 3 parts of sodium lauryl sulfate, 20 parts of acrylamide, 365 parts of styrene, 545 parts of butyl acrylate, and 10 parts of methacrrylic acid was continuously added dropwise to the reaction solution in four hours. After the completion of the addition, the resulting emulsion was maintained for three hours. After the thus-obtained aqueous emulsion was cooled down to room temperature, deionized water and sodium hydroxide aqueous solution were added to adjust pH to 8 to obtain an acrylic resin emulsion 1 (concentration of solid content of 30 percent by mass).

### Manufacturing Example 1

Manufacturing of Clear Ink A

A total of 25.0 parts of polyurethane resin emulsion 1 of Preparation Example 1 (solid portion concentration of 30 percent by mass), 19.0 parts of 1,2-propanediol, 11.0 parts of 1,3-propanediol, 3 parts of 1,2-butanediol, 2.5 parts of a surfactant (SILFACE SAG 503A, polyether-modified siloxane compound, effective component at 100 percent, manufactured by Nissin Chemical Co., Ltd.), and highly pure water were admixed to make the total 100 parts followed by stirring to prepare mixture.

Subsequently, the thus-obtained mixture was filtered with a polypropylene filter (Betafine polypropylene pleat filter PPG series, manufactured by 3M Company) with an average pore diameter of 0.2 micrometer to obtain clear ink A.

### Manufacturing Examples 2 to 16

Manufacturing of Clear Inks B to P

Clear inks B to were manufactured in the same manner as in Manufacturing Example 1 except that the ink composition was changed as shown in Tables 1-1 to 1-3.

TABLE 1-1

| | | Manufacturing | Manufacturing | Manufacturing | Manufacturing | Manufacturing | Manufacturing |
|---|---|---|---|---|---|---|---|
| | | Example 1 | Example 2 | Example 3 | Example 4 | Example 5 | Example 6 |
| | | Clear ink A | Clear ink B | Clear ink C | Clear ink D | Clear ink E | Clear ink F |
| Resin | Polyurethane resin emulsion 1 | 25.0 | 30.0 | 30.0 | 40.0 | — | 30.0 |
| | (water dispersible, solid portion | | | | | | |
| | concentration of 30 percent by | | | | | | |
| | mass) | | | | | | |
| | Acrylic resin emulsion 1 (water | — | — | — | — | 40.0 | — |
| | dispersible, solid portion | | | | | | |
| | concentration of 30 percent by | | | | | | |
| | mass) | | | | | | |
| | TAKELAC W-5030 (ester- | — | — | — | — | — | — |
| | based polyurethane resin | | | | | | |
| | emulsion, solid portion | | | | | | |
| | concentration: 30 percent by | | | | | | |
| | mass) | | | | | | |
| | TAKELAC W-6010 | — | — | — | — | — | — |
| | (carbonate-based urethane resin | | | | | | |
| | emulsion, solid portion | | | | | | |
| | concentration: 30 percent by | | | | | | |
| | mass) | | | | | | |
| Organic | 1,2-Propane diol | 19.0 | 17.4 | 18.0 | 15.0 | 15.0 | 18.0 |
| solvent | 1,3-Propane diol | 11.0 | 11.0 | 11.0 | 11.0 | 11.0 | 11.0 |
| | 1,2-Butane diol | 3.0 | 3.0 | 3.0 | 3.0 | 3.0 | 3.0 |
| | 3-methoxy-3-methyl-1-butane | — | — | — | — | — | — |
| | diol | | | | | | |
| | B-methoxy-N,N-dimethyl | — | — | — | — | — | — |
| | propioneamide | | | | | | |
| Surfactant | SILFACE SAG503A | 2.5 | 2.5 | 2.0 | 2.0 | 2.0 | — |
| | UNIDYNE ™ DSN403N | — | — | — | — | — | 0.5 |
| Water | Highly pure water | Balance | Balance | Balance | Balance | Balance | Balance |

| | | | | | | |
|---|---|---|---|---|---|---|
| Total (percent by mass) | 100.0 | 100.0 | 100.0 | 100.0 | 100.0 | 100.0 |
| Solid portion concentration of resin in clear | 7.5 | 9.0 | 9.0 | 12.0 | 12.0 | 9.0 |
| ink (percent by mass) | | | | | | |

TABLE 1-2

| | | Manufacturing | Manufacturing | Manufacturing | Manufacturing | Manufacturing | Manufacturing |
|---|---|---|---|---|---|---|---|
| | | Example 7 | Example 8 | Example 9 | Example 10 | Example 11 | Example 12 |
| | | Clear ink G | Clear ink H | Clear ink I | Clear ink J | Clear ink K | Clear ink L |
| Resin | Polyurethane resin emulsion 1 | 26.7 | 26.7 | 30.0 | 30.0 | — | — |
| | (water dispersible, solid portion | | | | | | |
| | concentration of 30 percent by | | | | | | |
| | mass) | | | | | | |
| | Acrylic resin emulsion 1 (water | — | — | — | — | — | — |
| | dispersible, solid portion | | | | | | |
| | concentration of 30 percent by | | | | | | |
| | mass) | | | | | | |
| | TAKELAC W-5030 (ester- | — | — | — | — | 33.3 | 40.0- |
| | based polyurethane resin | | | | | | |
| | emulsion, solid portion | | | | | | |
| | concentration: 30 percent by | | | | | | |
| | mass) | | | | | | |
| | TAKELAC W-6010 | — | — | — | — | — | — |
| | (carbonate-based urethane resin | | | | | | |
| | emulsion, solid portion | | | | | | |
| | concentration: 30 percent by | | | | | | |
| | mass) | | | | | | |
| Organic | 1,2-Propane diol | 19.0 | 19.0 | 17.4 | 18.0 | 15.0 | 15.0 |
| solvent | 1,3-Propane diol | 11.0 | 11.0 | 11.0 | 11.0 | — | — |
| | 1,2-Butane diol | 3.0 | 3.0 | 3.0 | 3.0 | 12.0 | 9.0 |
| | 3-methoxy-3-methyl-1-butane | — | — | — | — | 4.0 | 3.0 |
| | diol | | | | | | |
| | B-methoxy-N,N-dimethyl | — | — | — | — | 5.0 | 5.0 |
| | propioneamide | | | | | | |
| Surfactant | SILFACE SAG503A | 2.5 | 1.0 | 3.0 | 1.5 | 2.0 | 1.5 |
| | UNIDYNE ™ DSN403N | — | — | — | — | 0.1 | 0.2 |
| Water | Highly pure water | Balance | Balance | Balance | Balance | Balance | Balance |

| | | | | | | |
|---|---|---|---|---|---|---|
| Total (percent by mass) | 100.0 | 100.0 | 100.0 | 100.0 | 100.0 | 100.0 |
| Solid portion concentration of resin in clear | 8.0 | 8.0 | 9.0 | 9.0 | 10.0 | 12.0 |
| ink (percent by mass) | | | | | | |

TABLE 1-3

| | | Manufacturing | Manufacturing | Manufacturing | Manufacturing |
|---|---|---|---|---|---|
| | | Example 13 | Example 14 | Example 15 | Example 16 |
| | | Clear ink M | Clear ink N | Clear ink O | Clear ink P |
| Resin | Polyurethane resin emulsion 1 | — | — | — | — |
| | (water dispersible, solid portion | | | | |
| | concentration of 30 percent by | | | | |
| | mass) | | | | |
| | Acrylic resin emulsion 1 (water | — | — | — | — |
| | dispersible, solid portion | | | | |
| | concentration of 30 percent by | | | | |
| | mass) | | | | |
| | TAKELAC W-5030 (ester- | 20.0 | — | — | 10.0 |
| | based polyurethane resin | | | | |
| | emulsion, solid portion | | | | |
| | concentration: 30 percent by | | | | |
| | mass) | | | | |
| | TAKELAC W-6010 | 20.0 | 33.3 | 40.0 | 30.0 |
| | (carbonate-based urethane resin | | | | |
| | emulsion, solid portion | | | | |
| | concentration: 30 percent by | | | | |
| | mass) | | | | |
| Organic | 1,2-Propane diol | 15.0 | 20.0 | 20.0 | 20.0 |
| solvent | 1,3-Propane diol | — | — | — | — |
| | 1,2-Butane diol | 6.0 | 3.0 | — | — |
| | 3-methoxy-3-methyl-1-butane | 3.0 | 4.0 | 3.0 | 5.0 |
| | diol | | | | |
| | B-methoxy-N,N-dimethyl | 7.5 | 10.0 | 10.0 | 7.5 |
| | propioneamide | | | | |
| Surfactant | SILFACE SAG503A | 1.0 | 2.0 | 1.0 | 1.5 |
| | UNIDYNE ™ DSN403N | 0.3 | 0.1 | 0.3 | 0.2 |
| Water | Highly pure water | Balance | Balance | Balance | Balance |

| | | | | |
|---|---|---|---|---|
| Total (percent by mass) | 100.0 | 100.0 | 100.0 | 100.0 |
| Solid portion concentration of resin in clear | 12.0 | 10.0 | 12.0 | 12.0 |
| ink (percent by mass) | | | | |

The details of abbreviations and others shown in Tables 1 and 1 are as follows:
SILFACE SAG503A: (polyether-modified siloxane compound (effective component: 100 percent, manufactured by Nisshin Chemical Co., Ltd.)
UNIDYNE™ DSN403N: Polyoxyethylene perfluoroalkyl ether (effective component: 100 percent, manufactured by DAIKIN INDUSTRIES, LTD.)

### Manufacturing Example 17

Manufacture of Magenta Ink

Preparation of Self-Dispersible Magenta Pigment Dispersion

After preliminarily mixing the following recipe, the mixture was subjected to circulation dispersion for seven hours with a disk type bead mill (KDL type, media: zirconia ball having a diameter of 0.3 mm, manufactured by SHINMARU ENTERPRISES CORPORATION) to obtain a self-dispersible magenta pigment dispersion (pigment solid portion concentration: 15 percent by mass).
Pigment Red 122 (Toner Magenta E002, manufactured by Clariant (Japan) K.K.): 15 parts
Anionic surfactant (Pionine A-51-B, manufactured by TAKEMOTO OIL & FAT Co., Ltd.): 2 parts
Deionized water: 83 parts

Manufacture of Magenta Ink

Firstly, 25 parts of the polyurethane resin emulsion 1 (concentration of solid content: 30 percent by mass) of Preparation Example 1, 20 parts of self-dispersible magenta pigment dispersion (concentration of pigment solid portion: 15 percent by mass), 20 parts of 1,2-propane diol, aa parts of 1,3-propanediol, 3 parts of 1,2-butanediol, 0.6 parts of a fluorochemical surfactant (UNIDYNE™ DSN403N, concentration of solid content of 100 percent by mass, manufactured by DAIKIN INDUSTRIES, LTD.), and high-purity water were admixed to make the total 100 parts and stirred to prepare a mixture.

Thereafter, the thus-obtained mixture was filtered with a polyvinilydene fluoride membrane filter having an average pore diameter of 1.2 μm under pressure to prepare magenta ink.

Next, the manufacturing of the nozzle plate to be mounted on an inkjet head will be described.

### Manufacturing Example 101 of Nozzle Plate

Manufacturing of Nozzle Plate A

Synthesis of Fluorinated Polyacrylate A

Synthesis of Fluorine Monomer (MPOERfA) Having Ethylene Oxide Chain

The synthesis reaction of the fluorine monomer having an ethylene oxide chain is illustrated below.

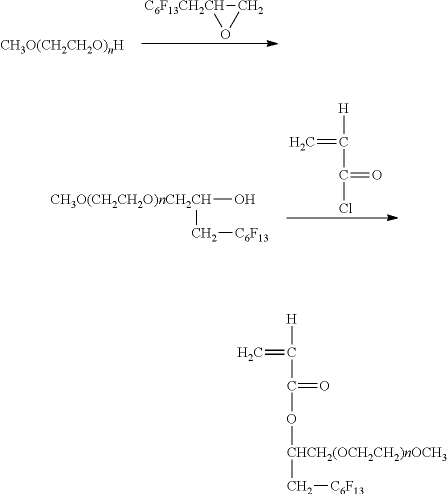

In the chemical reaction, the average of n is from 8 to 9.

Next, a four-necked flask was charged with 52.13 parts of a single-ended methoxypolyethylene glycol (average EO: 8 to 9, UNIOX M-400, manufactured by NOF Corporation) and 0.94 parts of boron trifluoride diethyl ether complex. In a nitrogen atmosphere, 50 parts of 3-perfluorohexyl-1,2-epoxypropane was added dropwise at room temperature in 30 to 40 minutes while paying attention to heat generation. After completion of the addition dropwise, the reaction was allowed to continue at room temperature for approximately two hours. Thereafter, it was confirmed by gas chromatography (GC) that the peak of 3-perfluorohexyl-1,2-epoxypropane had disappeared. To this reaction product, 0.03 parts of tertiary butyl catechol was added followed by stirring.

Further, 14.81 parts of triethylamine was added and 12.04 parts of acrylic acid chloride was added dropwise over approximately 20 minutes while paying attention to heat generation. After completion of the addition dropwise, the reaction was allowed to continue at room temperature for approximately two hours and it was confirmed by GC that the peak of acrylic acid chloride had almost disappeared.

The product was identified by the IR spectrum, ¹H-NMR and ¹⁹F-NMR spectra.

Synthesis of Fluorinated Polyacrylate A

In a 200 mL four-necked flask, 60 parts of isopropyl alcohol was placed against a monomer composition of 10 parts of the synthesized MPOERfA monomer, 60 pars of 2-(perfluorohexyl)ethyl acrylate, 20 parts of polyethylene glycol monoacrylate (EO: 10 mol, AE-400, manufactured by NOF CORPORATION), 5 parts of 2-hydroxyethyl acrylate, 2.5 parts of acetoacetoxyethyl methacrylate, and 2.5 parts of dimethylaminoethyl acrylate followed by blowing nitrogen into the flask for 60 minutes to replace the air in the system with nitrogen. While continuing the nitrogen blowing, the internal temperature was raised to 75 to 80 degrees C. Thereafter, 0.25 parts of azobisisobutyronitrile was added to allow polymerization reaction for eight hours.

When the liquid polymer was analyzed by gas chromatography (GC) and gel permeation chromatography, it was confirmed that the peak derived from the monomer had almost disappeared and the peak derived from a polymer had appeared.

The weight average molecular weight of the thus-obtained polymer was 17,000 (in polystyrene conversion).

Finally, 0.42 parts of acetic acid was added for neutralization and the mixture was diluted with water to obtain a 20 percent by mass solution of the fluorinated polyacrylate A.

Manufacturing of Nozzle Plate

Next, a nozzle substrate made of stainless steel (SUS304) nozzle substrate of 34 mm×16 mm with an average thickness of 20 μm was prepared,

On the nozzle substrate, four rows, each having 320 nozzles having an average hole diameter of 25 μm, were formed with a shortest distance between the centers of the nozzles of 85 μm (300 dpi).

A solution of the prepared fluorinated polyacrylate A at 20 percent by mass was applied to the surface of the nozzle substrate on the ink discharging side by dipping and dried to form an ink repellent film having an average thickness of 50 nm.

Thus, the nozzle plate A of Manufacturing Example 101 was manufactured.

At this time, the nozzles were masked with a water-soluble resin and the back surface of the nozzle substrate was masked with a tape. After forming a film, the tape was peeled off and removed. Further, the film was formed by heating the film at 120 degrees C. for one hour to form an ink repellent film.

### Manufacturing Example 102 of Nozzle Plate

Manufacturing of Nozzle Plate B

Synthesis of Fluorinated Polyacrylate B

Synthesis of Rf Epoxy Adduct (FAGMA) with 2-hydroxyethyl Acrylate (HEA)

The synthesis reaction formula of the Rf epoxy adduct with 2-hydroxyethyl acrylate is shown below.

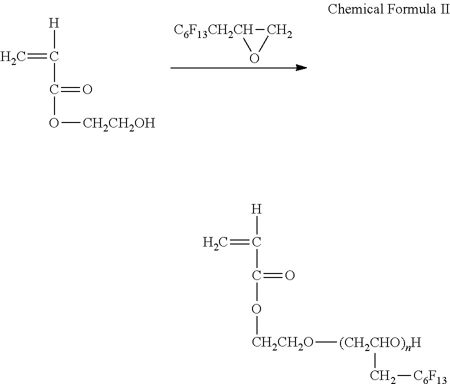

In the chemical reaction, n is from 1 to 3.

A four-necked flask was charged with 20 parts of 2-hydroxyethyl acrylate (HEA), 0.61 parts of boron trifluoride diethyl ether complex, and 0.026 parts of tertiary-butyl catechol. A total of 64.83 parts of 3-perfluorohexyl-1,2-epoxypropane was dripped at room temperature in 30 to 40 minutes while paying attention to heat generation.

After completion of the dripping, the reaction was allowed to continue at room temperature for approximately two hours. Thereafter, it was confirmed by gas chromatography (GC) that the peak of 3-perfluorohexyl-1,2-epoxypropane had disappeared.

After completion of the reaction, the reaction product was dissolved in 100 parts of 1,1-dichloro-1,2,2,3,3-pentafluoropropane (HCFC225) and 100 parts of water was further added. Thereafter, the resulting solution was rinsed and liquid-separated to extract an organic layer.

This rinsing and liquid separation operation was repeated once again and after extracting the organic layer, 5 parts of anhydrous magnesium sulfate was added followed by drying overnight.

HCFC225 was evaporated to obtain an Rf epoxy adduct (FAGMA) with HEA. The reaction product was identified by the IR spectrum, ¹H-NMR and ¹⁹F-NMR spectra. As a result of the analysis results of the product, approximately 64 part of a monomer mixture of 1 mol adduct (n=1) of 3-perfluorohexyl-1,2-epoxypropane, approximately 27 parts of 2-mol adduct (n=2), and approximately 9 parts of 3 mol adduct was obtained.

Synthesis of Fluorinated Monomer Containing Sulfonic Acid

The synthesis reaction of the fluorinated monomer containing sulfonic acid is illustrated below.

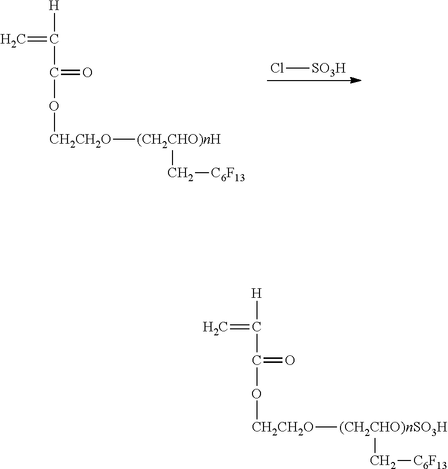

In the chemical reaction, n is from 1 to 3.

A total of 30 parts of the synthesized Rf epoxy adduct (FAGMA) with HEA, 30 parts of dichloromethane, 7.8 g of triethylamine, and 0.024 parts of hydroquinone monomethyl ether were charged into a four-necked flask. This liquid mixture was cooled down in an ice bath in such a manner that the temperature was 0 to 10 degrees C. A dichloromethane solution (7.48 parts of chlorosulfonic acid+15 parts of dichloromethane) of chlorosulfonic acid was gradually added dropwise thereto over approximately 30 minutes while paying attention to heat generation. After completion of the dripping, the reaction was allowed to continue at room temperature for three hours. A total of 100 parts of water was added to the reaction product and the rinsing and liquid separation operations were repeated twice. The organic layer was extracted and 5 parts of anhydrous magnesium sulfate was added followed by drying overnight.

The reaction product (fluorinated monomer containing sulfonic acid) was identified by the IR spectrum, ¹H-NMR, and ¹⁹F-NMR spectra.

Synthesis of Fluorinated Polyacrylate B

Fluorinated polyacrylate B was synthesized in the same manner as in Manufacturing Example 101 except that the monomer composition was changed to 60 parts of 2-(perfluorohexyl) ethyl acrylate, 20 parts of the fluorinated monomer containing sulfonic acid group, 17.5 parts of polyethylene glycol monoacrylate (EO: 10 mol, AE-400, manufactured by NOF Corporation), and 2.5 parts of acetoacetoxyethyl methacrylate.

The weight average molecular weight of the thus-obtained copolymer was 17,000 (in polystyrene conversion).

Finally, 0.42 parts of acetic acid was added for neutralization and the mixture was diluted with water to obtain a 20 percent by mass solution of the fluorinated polyacrylate B.

Manufacturing of Nozzle Plate

A 20 percent by mass solution of the prepared fluorinated polyacrylate B was applied to the surface of the same nozzle substrate as in Manufacturing Example 101 on the ink discharging side by dipping followed by drying to form an ink repellent film having an average thickness of 30 nm. Thus, the nozzle plate B of Manufacturing Example 102 was manufactured.

At this time, the nozzles were masked with a water-soluble resin and the back surface of the nozzle substrate was masked with a tape. After forming the ink repellent film, the tape was peeled off and removed. Further, the film was formed by heating the film at 120 degrees C. for one hour to form an ink repellent film.

### Manufacturing Example 103 of Ink

Manufacturing of Nozzle Plate C

A fluorinated polyacrylate solution (OPTOOL DSX, manufactured by DAIKIN INDUSTRIES, LTD.) was prepared.

The prepared fluorinated polyacrylate solution (OPTOOL DSX, manufactured by DAIKIN INDUSTRIES, LTD.) was applied to the surface of the same nozzle substrate as in Manufacturing Example 101 on the ink discharging side by dipping followed by drying to form an ink repellent film having an average thickness of 20 nm. Thus, the nozzle plate C of Manufacturing Example 103 was manufactured.

At this time, the nozzles were masked with a water-soluble resin and the back surface of the nozzle substrate was masked with a tape. After forming the ink repellent film, the tape was peeled off and removed.

Further, the film was formed by heating the film at 120 degrees C. for one hour to form an ink repellent film.

### Manufacturing Example 104 of Ink

Manufacturing of Nozzle Plate D

Silicone resin solution (SR 2441 RESIN, manufactured by Dow Corning Toray Co., Ltd.) was prepared.

The prepared silicone resin solution was applied to the surface of the same nozzle substrate as in Manufacturing Example 101 on the ink discharging side by dipping followed by drying to form an ink repellent film having an average thickness of 100 nm. Thus, the nozzle plate D of Manufacturing Example 104 was manufactured.

At this time, the nozzles were masked with a water-soluble resin and the back surface of the nozzle substrate was masked with a tape. After forming the ink repellent film, the tape was peeled off and removed.

This was heated and cured at 150 degrees C. for two hours in the atmosphere to form an ink repellent film.

### Manufacturing Example 105 of Ink

Manufacturing of Nozzle Plate E

A liquid diluted to 0.2 percent by mass, which was prepared by diluting CYTOP CTX-105 (manufactured by Asahi Glass Co., Ltd.) with a liquid mixture of Ct-solv. 100 (manufactured by ASAHI GLASS CO., LTD.) and Ct-solv. 180 (manufactured by ASAHI GLASS CO., LTD.) with a volume ratio of 1:1, was used as the ink repellent treatment agent. Silicone rubber was placed on a spinner and 2 mL of this solution was added dropwise on the silicone rubber. After the addition dropwise, the liquid was rotated on the spinner to produce a uniform film.

The rate of rotation was set to firstly 1,000 rpm for 5 seconds and secondly 3,000 rpm for 20 seconds.

The same nozzle substrate surface as in Manufacturing Example 101 was pressed against the silicone rubber to transfer the film. The number of transfer was three times and the pressing pressure was 2 kg/head.

After the transfer was completed, the head was placed in an oven at 150 degrees C. for two and a half hours for heat treatment to prepare a nozzle plate E of Manufacturing Example 105.

### Manufacturing Example 106 of Nozzle Plate

Manufacturing of Nozzle Plate F

A liquid diluted to 0.5 percent by mass prepared by diluting AF1600 (Teflon® AF, manufactured by E.I. du Pont de Nemours and Company) with Fluorinert FC-75 (manufactured by 3M Company) was used as the ink repellent treatment agent.

Silicone rubber was placed on a spinner and 2 mL of this solution was dripped on the silicone rubber in the same manner as in Manufacturing Example 105. After the addition dropwise, the liquid was rotated on the spinner to produce a uniform film.

The rate of rotation was set to firstly 1,000 rpm for 5 seconds and secondly 3,000 rpm for 20 seconds.

The same nozzle substrate surface as in Manufacturing Example 1 was pressed against the silicone rubber to transfer the film. The number of transfer was three times and the pressing pressure was 2 kg/head.

After the transfer was completed, the head was placed in an oven at 165 degrees C. for two and a half hours for heat treatment to prepare a nozzle plate F of Manufacturing Example 106.

### Example 1

Inkjet Printing

An ink cartridge of an inkjet printer (GXe5500 remodeled machine, manufactured by Ricoh Co., Ltd.) to which the nozzle plate A was mounted was filled with the clear ink A of Manufacturing Example 1. Thereafter, the ink cartridge filled with the ink was mounted to the inkjet printer GXe5500 remodeled machine followed by inkjet printing.

The inkjet printer GXe 5500 remodeled machine was provided with a heater (temperature controller, model MTCD, available from MISUMI, Inc.) so that the recording medium could be heated from the back side before, during, and after printing. This configuration of the inkjet printer Gxe5500 remodeled machine enabled printing on a recording medium heated by the heaters before and during printing and heat drying the print product by the heater. In the high gloss printing mode (second printing mode) and low gloss printing mode (first printing mode), different images were printed on different recording media and under different heating conditions.

Recording Medium

In the high gloss printing mode, synthetic paper VJFN160 (white polypropylene film, gloss 16 (60° gloss value), manufactured by Yupo Corporation) was used as the recording medium 1.

In the low gloss printing mode, a window film GIY-0305 (transparent polyethylene terephthalate (PET) film, gloss 159 (60 degree gloss value, manufactured by Lintec Corporation) was used as the recording medium 2.

Heating Conditions

In the high gloss printing mod (second printing mode), the heating temperatures of each heater (heating device) disposed before printing, during printing, and after printing were set at 60 degrees C., 60 degrees C., and 70 degrees C., respectively. The heating temperatures of each heater were set at 65 degrees C., 65 degrees C., and 70 degrees C., respectively, in the low gloss printing mode (first printing mode). The temperature T_{gloss} of the recording medium measured during printing was 59 degrees C. in the high gloss printing mode and the temperature Tₘₐₜₜₑ of the recording medium measured during printing was 64 degrees C. in the low gloss printing mode.

The temperature of the recording medium during printing was measured by a digital radiation temperature sensor (FT-H10, manufactured by KEYENCE CORPORATION).

The image printed in the high gloss printing mode was a solid image with an image resolution of 600 dpi×600 dpi with a printing ratio of 100 percent.

The image printed in the low gloss printing mode was a halftone image with an image resolution of 600 dpi×600 dpi with a printing ratio of 40 percent.

Printing Ratio

The printing ratio means the following.

Printing ratio (percent)={(number of printed dots of clear ink)/(longitudinal resolution×latitudinal resolution)}×100

The number of printed dots of clear ink means the number of dots of clear ink actually applied per unit of area and longitudinal resolution and latitudinal each resolution represent resolutions per unit of area. When clear ink is disposed at the same dot position in an overlapping manner for printing, “the number of clear ink printing dots” represents the total number of dots per unit area actually used for printing with clear ink.

The recording medium is subjected to printing with the clear ink A in such a manner that the clear ink A was directly overlapped once at the same dot position in both the low gloss printing mode and high gloss printing mode.

Next, the gloss of the thus-obtained print product was measured in the following manner. The results are shown in Table 3-1.

Gloss

The 60 degree gloss value was measured at both the clear ink printing portion printed with the clear ink A and the non clear ink printing portion (i.e., recording medium) printed with no clear ink A was measured by a gloss measuring instrument (micro-tri-gloss, manufactured by BYK). The 60° gloss value was determined as the gloss degree.

### Example 2

Inkjet printing was conducted in the same manner as in Example 1 except that the nozzle plate B was mounted onto the inkjet printer Gxe 5500 (manufactured by Ricoh Co., Ltd.), and the image printed in the high gloss printing mode was changed to a halftone image having an image resolution of 600 dpi×600 dpi with a printing ratio of 80 percent and the image printed in the low gloss printing mode was changed to a halftone image having an image resolution of 600 dpi×600 dpi with a printing ratio of 70 percent.

The gloss of the thus-obtained print products was measured in the same manner as in Example 1. The results are shown in Table 3-1.

### Example 3

The print product of Example 3 was obtained in the same manner as in Example 1 except that the nozzle plate C was mounted onto the inkjet printer Gxe 5500 (manufactured by Ricoh Co., Ltd.) and the heating temperatures of each heater disposed before, during, and after printing in the high gloss printing mode were respectively set to 50 degrees C., 50 degrees C., and 70 degrees C. and the heating temperatures of each heater disposed before, during, and after printing in the low gloss printing mode were respectively set to 70 degrees C., 70 degrees C., and 70 degrees C. The gloss of the thus-obtained print products was measured in the same manner as in Example 1. The results are shown in Table 3-1.

The temperature T_{gloss} of the recording medium measured during printing was 49 degrees C. in the high gloss printing mode and the temperature Tₘₐₜₜₑ of the recording medium measured during printing was 68 degrees C. in the low gloss printing mode.

### Example 4

The print product of Example 4 was obtained in the same manner as in Example 3 except that the nozzle plate D was mounted onto the inkjet printer Gxe 5500 (manufactured by Ricoh Co., Ltd.) and the clear ink A of Manufacturing Example 1 was changed to the clear ink B of Manufacturing Example 2.

The gloss of the thus-obtained print products was measured in the same manner as in Example 1. The results are shown in Table 3-1.

### Example 5

The print product of Example 5 was obtained in the same manner as in Example 3 except that the nozzle plate E was mounted onto the inkjet printer Gxe 5500 (manufactured by Ricoh Co., Ltd.) and the clear ink A of Manufacturing Example 1 was changed to the clear ink C of Manufacturing Example 3.

The gloss of the thus-obtained print products was measured in the same manner as in Example 1. The results are shown in Table 3-1.

### Example 6

The print product of Example 6 was obtained in the same manner as in Example 3 except that the nozzle plate F was mounted onto the inkjet printer Gxe 5500 (manufactured by Ricoh Co., Ltd.) and the clear ink A of Manufacturing Example 1 was changed to the clear ink D of Manufacturing Example 4.

The gloss of the thus-obtained print products was measured in the same manner as in Example 1. The results are shown in Table 3-1.

### Example 7

The print product of Example 7 was obtained in the same manner as in Example 3 except that the nozzle plate A was mounted onto the inkjet printer Gxe 5500 (manufactured by Ricoh Co., Ltd.) and the clear ink A of Manufacturing Example 1 was changed to the clear ink E of Manufacturing Example 5.

The gloss of the thus-obtained print products was measured in the same manner as in Example 1. The results are shown in Table 3-1.

### Example 8

Inkjet printing was conducted in the same manner as in Example 7 except that the recording medium printed with the magenta ink of Manufacturing Example 6 was used. That is, the clear ink E was printed on the coating film formed of the magenta ink.

The magenta ink of Manufacturing Example 6 was used for printing on the recording medium. The magenta ink was applied by the same inkjet printing device as for the clear ink. The heating temperatures of the heater disposed before, during, and after printing for the magenta ink film used in the high gloss printing mode were respectively set to 50 degrees C., 50 degrees C., and 70 degrees C. and the heating temperatures of the heater disposed before, during, and after printing for the magenta ink film used in the low gloss printing mode were respectively set to 70 degrees C., 70 degrees C., and 70 degrees C. to apply the magenta ink alone onto the recording medium. The image printed with the magenta ink was a solid image with an image resolution of 600 dpi×600 dpi with a printing ratio of 100 percent.

The inkjet printing device was used to print again with clear ink E on the recording medium on which the magenta ink film was formed.

The gloss of the thus-obtained print products was measured in the same manner as in Example 1. The results are shown in Table 3-1.

### Example 9

The print product of Example 9 was obtained in the same manner as in Example 1 except that the nozzle plate A was mounted onto the inkjet printer Gxe 5500 (manufactured by Ricoh Co., Ltd.) and the clear ink A of Manufacturing Example 1 was changed to the clear ink G of Manufacturing Example 7.

The gloss of the thus-obtained print products was measured in the same manner as in Example 1. The results are shown in Table 3-1.

### Example 10

The print product of Example 7 was obtained in the same manner as in Example 3 except that the nozzle plate A was mounted onto the inkjet printer Gxe 5500 (manufactured by Ricoh Co., Ltd.) and the clear ink A of Manufacturing Example 1 was changed to the clear ink H of Manufacturing Example 8.

The gloss of the thus-obtained print products was measured in the same manner as in Example 1. The results are shown in Table 3-1.

### Example 11

The print product of Example 11 was obtained in the same manner as in Example 4 except that the nozzle plate D was mounted onto the inkjet printer Gxe 5500 (manufactured by Ricoh Co., Ltd.) and the clear ink B of Manufacturing Example 2 was changed to the clear ink I of Manufacturing Example 9.

The gloss of the thus-obtained print products was measured in the same manner as in Example 1. The results are shown in Table 3-1.

### Example 12

The print product of Example 12 was obtained in the same manner as in Example 5 except that the nozzle plate E was mounted onto the inkjet printer Gxe 5500 (manufactured by Ricoh Co., Ltd.) and the clear ink C of Manufacturing Example 3 was changed to the clear ink J of Manufacturing Example 10.

The gloss of the thus-obtained print products was measured in the same manner as in Example 1. The results are shown in Table 3-1.

### Examples 13 to 18

Inkjet printing of Examples 13 to 18 was conducted in the same manner as in Example 3 except that the clear inks and/or nozzle plates were changed as shown in Tables 2-1 and 2-2.

The gloss of the thus-obtained print products was measured in the same manner as in Example 1. The results are shown in Table 3-1.

### Comparative Example 1

The print product of Comparative Example 1 was obtained in the same manner as in Example 2 except that the same temperatures of the heater in the high gloss printing mode were respectively set to 65 degrees C., 65 degrees C., and 70 degrees C. as those in the low gloss printing mode. The gloss of the thus-obtained print products was measured in the same manner as in Example 1. The results are shown in Table 3-1.

The temperature T_{gloss} of the recording medium measured during printing was 64 degrees C. in the high gloss printing mode and the temperature Tₘₐₜₜₑ of the recording medium measured during printing was 64 degrees C. in the low gloss printing mode.

### Comparative Example 2

The print product of Comparative Example 2 was obtained in the same manner as in Example 1 except that the same temperatures of the heater in the high gloss printing mode were respectively set to 65 degrees C., 65 degrees C., and 70 degrees C. as those in the low gloss printing mode.

The gloss of the thus-obtained print products was measured in the same manner as in Example 1. The results are shown in Table 3-1.

The temperature T_{gloss} of the recording medium measured during printing was 64 degrees C. in the high gloss printing mode and the temperature Tₘₐₜₜₑ of the recording medium measured during printing was 64 degrees C. in the low gloss printing mode.

### Comparative Example 3

The magenta ink of Manufacturing Example 6 was printed on the recording medium. The magenta ink was applied by the same inkjet printing device as for the clear ink. The heating temperatures of the heater disposed before, during, and after printing for the magenta ink film used in the high gloss printing mode were respectively set to 50 degrees C., 50 degrees C., and 70 degrees C. and the heating temperatures of the heater disposed before, during, and after printing for the magenta ink film used in the low gloss printing mode were respectively set to 70 degrees C., 70 degrees C., and 70 degrees C.

The gloss of the thus-obtained print products was measured in the same manner as in Example 1. The results are shown in Table 3-1.

The magenta print image was a solid image printed with an image resolution of 600 dpi×600 dpi with a print ratio of 100 percent.

The gloss of the magenta ink film in the high gloss printing mode was 30 while the gloss of the foundation of the medium was 16 and the gloss of the magenta ink film in the low gloss printing mode was 102 while the gloss of the foundation of the medium was 159.

### Comparative Example 4

The print product of Comparative Example 4 was obtained in the same manner as in Comparative Example 2 except that the temperatures of the heater in the low gloss printing mode were respectively set to 60 degrees C., 60 degrees C., and 70 degrees C.

### Comparative Example 5

Inkjet printing was conducted in the same manner as in Example 2 except that the clear ink A of Manufacturing Example 1 was changed to the clear ink F of Manufacturing Example 6.

The gloss of the thus-obtained print products was measured in the same manner as in Example 1. The results are shown in Table 3-1.

Receding contact angle, discharging stability 1, and discharging stability 2 were evaluated in the following manner and the results are shown in Table 3-2.

Receding Contact Angle

In the environment of 25 degrees C., 2.0 μl of each ink shown in Table 2-1 was squeezed from a syringe having a syringe needle having an inner diameter of 0.37 μm with a length of 0.18 mm to the nozzle plate surface manufactured above, i.e., the ink repellent film facing the substrate. The receding contact angle at 25 degrees C. was measured by an automatic contact angle measuring device (DMo-501, manufactured by Kyowa Interface Science Co., Ltd.) according to the contraction method.

Discharging Stability 1

Continuous Discharging Evaluation

One litter of each ink adjusted for a discharging head for each color was flown by passage from the ink cartridge of the inkjet printing device (IPSiO Gxe-5500, manufactured by Ricoh Co., Ltd.) Immediately after the passage, the inkjet printing device continuously printed a chart of a solid image created by Microsoft Word 2000 with an area of 80 percent of A4 paper on My Paper (manufactured by Ricoh Co, Ltd.) with a run length of 200. After the printing, the nozzle check chart was printed and evaluated regarding discharging disturbance of each nozzle according to the following criteria.

The print mode used was: a modified mode in which Plain Paper—Standard Fast was modified to No Color Calibration from the user setting for plain paper by the driver installed onto the printer.

Evaluation Criteria

A: No discharging disturbance present
B: Slight discharging disturbance present
C: Discharging disturbance present or no discharging present
D: Significant discharging disturbance observed or many nozzles not discharging

Discharging Stability 2

Evaluation on Ink Repelling Time of Nozzle Plate

A total of 50 g of each ink shown in Table 2-1 was placed in a 50 mL beaker at a temperature of from 22.5 to 23.5 degrees C. and an RH of from 45 to 55 percent. The nozzle plate was taken out of the inkjet printing device (IPSiO Gxe-5500, manufactured by Ricoh Co., Ltd.), pinched with a pincer, and dipped in each ink at a rate of 315 mm/min. The ink repelling time (i.e., ink drawing time) from the ink repellent film from the nozzle plate taken out at the same rate and evaluated according to the following criteria. If the ink repelling time is long, the nozzle plate is readily wet with the ink so that the nozzle omission tends to occur in a continuous discharging evaluation.

### Evaluation Criteria

A: Ink repelling time of less than 10 seconds
B: Ink repelling time of 10 to less than 30 seconds
C: Ink repelling time of 30 to less than 60 seconds
D: Ink repelling time of 60 seconds or longer

TABLE 2-1

| | Printing condition | | | | |
|---|---|---|---|---|---|
| | | | Nozzle plate | | |
| | | | to be | Recording | |
| | Type of ink | Printing mode | evaluated | medium | Printed image |
| Example 1 | Clear ink A | High gloss | Nozzle plate | VJFN 160 | All solid image |
| | | Low gloss | A | GIY0305 | Half tone image |
| Example 2 | Clear ink A | High gloss | Nozzle plate | VJFN 160 | Half tone image |
| | | Low gloss | B | GIY0305 | Half tone image |
| Example 3 | Clear ink A | High gloss | Nozzle plate | VJFN 160 | All solid image |
| | | Low gloss | C | GIY0305 | Half tone image |
| Example 4 | Clear ink B | High gloss | Nozzle plate | VJFN 160 | All solid image |
| | | Low gloss | D | GIY0305 | Half tone image |
| Example 5 | Clear ink C | High gloss | Nozzle plate | VJFN 160 | All solid image |
| | | Low gloss | E | GIY0305 | Half tone image |
| Example 6 | Clear ink D | High gloss | Nozzle plate | VJFN 160 | All solid image |
| | | Low gloss | F | GIY0305 | Half tone image |
| Example 7 | Clear ink E | High gloss | Nozzle plate | VJFN 160 | All solid image |
| | | Low gloss | A | GIY0305 | Half tone image |
| Example 8 | Clear ink E + | High gloss | Nozzle plate | VJFN 160 | All solid image |
| | magenta ink | Low gloss | A | GIY0305 | Half tone image |
| Example 9 | Clear ink G | High gloss | Nozzle plate | VJFN 160 | All solid image |
| | | Low gloss | A | GIY0305 | Half tone image |
| Example 10 | Clear ink H | High gloss | Nozzle plate | VJFN 160 | All solid image |
| | | Low gloss | A | GIY0305 | Half tone image |
| Example 11 | Clear ink I | High gloss | Nozzle plate | VJFN 160 | All solid image |
| | | Low gloss | D | GIY0305 | Half tone image |
| Example 12 | Clear ink J | High gloss | Nozzle plate | VJFN 160 | All solid image |
| | | Low gloss | E | GIY0305 | Half tone image |
| Example 13 | Clear ink K | High gloss | Nozzle plate | VJFN 160 | All solid image |
| | | Low gloss | C | GIY0305 | Half tone image |
| Example 14 | Clear ink L | High gloss | Nozzle plate | VJFN 160 | All solid image |
| | | Low gloss | D | GIY0305 | Half tone image |
| Example 15 | Clear ink M | High gloss | Nozzle plate | VJFN 160 | All solid image |
| | | Low gloss | E | GIY0305 | Half tone image |
| Example 16 | Clear ink N | High gloss | Nozzle plate | VJFN 160 | All solid image |
| | | Low gloss | F | GIY0305 | Half tone image |
| Example 17 | Clear ink O | High gloss | Nozzle plate | VJFN 160 | All solid image |
| | | Low gloss | A | GIY0305 | Half tone image |
| Example 18 | Clear ink P | High gloss | Nozzle plate | VJFN 160 | All solid image |
| | | Low gloss | A | GIY0305 | Half tone image |
| Comparative | Clear ink A | High gloss | Nozzle plate | VJFN 160 | Half tone image |
| Example 1 | | Low gloss | B | GIY0305 | Half tone image |
| Comparative | Clear ink A | High gloss | Nozzle plate | VJFN 160 | All solid image |
| Example 2 | | Low gloss | A | GIY0305 | Half tone image |
| Comparative | Magenta ink | High gloss | Nozzle plate | VJFN 160 | All solid image |
| Example 3 | | Low gloss | B | GIY0305 | All solid image |
| Comparative | Clear ink A | High gloss | Nozzle plate | VJFN 160 | All solid image |
| Example 4 | | Low gloss | A | GIY0305 | Half tone image |
| Comparative | Clear ink F | High gloss | Nozzle plate | VJFN 160 | All solid image |
| Example 5 | | Low gloss | B | GIY0305 | Half tone image |

TABLE 2-2

| | Printing condition | | | | | |
|---|---|---|---|---|---|---|
| | | | How | | | |
| | | | many | | | |
| | | | times | | | |
| | | | clear | | | |
| | Printed | | ink is | Heater temperature | | |
| | region of | Printing | over- | Before | During | After |
| | clear in | ratio | lapped | printing | printing | printing |
| Example 1 | Recording | 100 | Once | 60 | 60 | 70 |
| | medium | percent | | degrees | degrees | degrees |
| | | | | C. | C. | C. |
| | Recording | 40 | Once | 65 | 65 | 70 |
| | medium | percent | | degrees | degrees | degrees |
| | | | | C. | C. | C. |
| Example 2 | Recording | 80 | Once | 60 | 60 | 70 |
| | medium | percent | | degrees | degrees | degrees |
| | | | | C. | C. | C. |
| | Recording | 70 | Once | 65 | 65 | 70 |
| | medium | percent | | degrees | degrees | degrees |
| | | | | C. | C. | C. |
| Example 3 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 4 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 5 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 6 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 7 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 8 | Magenta | 100 | Once | 50 | 50 | 70 |
| | ink image | percent | | degrees | degrees | degrees |
| | | | | C. | C. | C. |
| | Magenta | 40 | Once | 70 | 70 | 70 |
| | ink image | percent | | degrees | degrees | degrees |
| | | | | C. | C. | C. |
| Example 9 | Recording | 100 | Once | 60 | 60 | 70 |
| | medium | percent | | degrees | degrees | degrees |
| | | | | C. | C. | C. |
| | Recording | 40 | Once | 65 | 65 | 70 |
| | medium | percent | | degrees | degrees | degrees |
| | | | | C. | C. | C. |
| Example 10 | Recording | 100 | Once | 60 | 60 | 70 |
| | medium | percent | | degrees | degrees | degrees |
| | | | | C. | C. | C. |
| | Recording | 40 | Once | 65 | 65 | 70 |
| | medium | percent | | degrees | degrees | degrees |
| | | | | C. | C. | C. |
| Example 11 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 12 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 13 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 14 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 15 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 16 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 17 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| Example 18 | Recording | 100 | Once | 50 | 50 | 70 |
| | medium | percent | | degrees | degrees | degrees |
| | | | | C. | C. | C. |
| | Recording | 40 | Once | 70 | 70 | 70 |
| | medium | percent | | degrees | degrees | degrees |
| | | | | C. | C. | C. |
| C.omparative | Recording | 80 | Once | 65 | 65 | 70 |
| Example 1 | medium | percent | | degrees | degrees | degrees |
| | | | | C. | C. | C. |
| | Recording | 70 | Once | 65 | 65 | 70 |
| | medium | percent | | degrees | degrees | degrees |
| | | | | C. | C. | C. |
| C.omparative | Recording | 100 | Once | 65 | 65 | 70 |
| Example 2 | medium | percent | | degrees | degrees | degrees |
| | | | | C. | C. | C. |
| | Recording | 40 | Once | 65 | 65 | 70 |
| | medium | percent | | degrees | degrees | degrees |
| | | | | C. | C. | C. |
| C.omparative | Not | 100 | — | 50 | 50 | 70 |
| Example 3 | printed | percent | | degrees | degrees | degrees |
| | | | | C. | C. | C. |
| | Not | 100 | — | 70 | 70 | 70 |
| | printed | percent | | degrees | degrees | degrees |
| | | | | C. | C. | C. |
| C.omparative | Recording | 100 | Once | 65 | 65 | 70 |
| Example 4 | medium | percent | | degrees | degrees | degrees |
| | | | | C. | C. | C. |
| | Recording | 40 | Once | 60 | 60 | 70 |
| | medium | percent | | degrees | degrees | degrees |
| | | | | C. | C. | C. |
| C.omparative | Recording | 80 | Once | 60 | 60 | 70 |
| Example 5 | medium | percent | | degrees | degrees | degrees |
| | | | | C. | C. | C. |
| | Recording | 70 | Once | 65 | 65 | 70 |
| | medium | percent | | degrees | degrees | degrees |
| | | | | C. | C. | C. |

TABLE 3-1

| | Temperature | | | | |
|---|---|---|---|---|---|
| | of recording | | | | |
| | medium | | Evaluation result | | |
| | during | | Glossiness | | Gloss difference |
| | printing | | Clear ink printed | Clear ink non- | Printed portion - |
| | (degrees C) | | portion | printed portion | Nonprinted portion |
| Example 1 | T_{gloss} | 59 | 58 | 16 | 42 |
| | Tₘₐₜₜₑ | 64 | 112 | 159 | −47 |
| Example 2 | T_{gloss} | 59 | 42 | 16 | 26 |
| | Tₘₐₜₜₑ | 64 | 131 | 159 | −28 |
| Example 3 | T_{gloss} | 49 | 67 | 16 | 51 |
| | Tₘₐₜₜₑ | 68 | 103 | 159 | −56 |
| Example 4 | T_{gloss} | 49 | 69 | 16 | 53 |
| | Tₘₐₜₜₑ | 68 | 96 | 159 | −63 |
| Example 5 | T_{gloss} | 49 | 68 | 16 | 52 |
| | Tₘₐₜₜₑ | 68 | 85 | 159 | −74 |
| Example 6 | T_{gloss} | 49 | 72 | 16 | 56 |
| | Tₘₐₜₜₑ | 68 | 77 | 159 | −82 |
| Example 7 | T_{gloss} | 49 | 73 | 16 | 57 |
| | Tₘₐₜₜₑ | 68 | 83 | 159 | −76 |
| Example 8 | T_{gloss} | 49 | 85 | 30 | 55 |
| | Tₘₐₜₜₑ | 68 | 39 | 102 | −63 |
| Example 9 | T_{gloss} | 59 | 63 | 16 | 47 |
| | Tₘₐₜₜₑ | 64 | 114 | 159 | −45 |
| Example 10 | T_{gloss} | 59 | 57 | 16 | 41 |
| | Tₘₐₜₜₑ | 64 | 111 | 159 | −48 |
| Example 11 | T_{gloss} | 49 | 73 | 16 | 57 |
| | Tₘₐₜₜₑ | 68 | 98 | 159 | −61 |
| Example 12 | T_{gloss} | 49 | 67 | 16 | 51 |
| | Tₘₐₜₜₑ | 68 | 84 | 159 | −75 |
| Example 13 | T_{gloss} | 49 | 68 | 16 | 52 |
| | Tₘₐₜₜₑ | 68 | 104 | 159 | −55 |
| Example 14 | T_{gloss} | 49 | 72 | 16 | 56 |
| | Tₘₐₜₜₑ | 68 | 100 | 159 | −59 |
| Example 15 | T_{gloss} | 49 | 78 | 16 | 62 |
| | Tₘₐₜₜₑ | 68 | 90 | 159 | −69 |
| Example 16 | T_{gloss} | 49 | 79 | 16 | 63 |
| | Tₘₐₜₜₑ | 68 | 77 | 159 | −82 |
| Example 17 | T_{gloss} | 49 | 84 | 16 | 68 |
| | Tₘₐₜₜₑ | 68 | 88 | 159 | −71 |
| Example 18 | T_{gloss} | 49 | 83 | 16 | 67 |
| | Tₘₐₜₜₑ | 68 | 85 | 159 | −74 |
| Comparative | T_{gloss} | 64 | 30 | 16 | 14 |
| Example 1 | Tₘₐₜₜₑ | 64 | 139 | 159 | −20 |
| Comparative | T_{gloss} | 64 | 35 | 16 | 19 |
| Example 2 | Tₘₐₜₜₑ | 64 | 137 | 159 | −22 |
| Comparative | T_{gloss} | 64 | Unable to measure | Unable to measure | Unable to measure |
| Example 3 | Tₘₐₜₜₑ | 64 | Unable to measure | Unable to measure | Unable to measure |
| Comparative | T_{gloss} | 64 | 35 | 16 | 19 |
| Example 4 | Tₘₐₜₜₑ | 59 | 141 | 159 | −18 |
| Comparative | T_{gloss} | 59 | 42 | 16 | 26 |
| Example 5 | Tₘₐₜₜₑ | 64 | 131 | 159 | −28 |

*“Unable to measure” in Comparative Example 3 in Table 3-1 means unable to measure gloss.

TABLE 3-2

| | Evaluation result | | |
|---|---|---|---|
| | | Discharging | |
| | | stability 1 | Discharging |
| | Receding | Continuous | stability 2 |
| | contact angle | discharging | Ink repelling |
| | (degrees) | evaluation | time |
| Example 1 | 70 | A | A |
| Example 2 | 67 | A | A |
| Example 3 | 60 | A | A |
| Example 4 | 38 | B | B |
| Example 5 | 42 | A | B |
| Example 6 | 64 | A | A |
| Example 7 | 72 | A | A |
| Example 8 | 72 | A | A |
| Example 9 | 68 | A | A |
| Example 10 | 80 | A | A |
| Example 11 | 35 | B | B |
| Example 12 | 40 | A | B |
| Example 13 | 52 | A | A |
| Example 14 | 41 | A | A |
| Example 15 | 36 | B | B |
| Example 16 | 54 | A | A |
| Example 17 | 38 | A | B |
| Example 18 | 44 | A | A |
| Comparative | 69 | A | A |
| Example 1 | | | |
| Comparative | 69 | A | A |
| Example 2 | | | |
| Comparative | 30 | D | D |
| Example 3 | | | |
| Comparative | 69 | A | A |
| Example 4 | | | |
| Comparative | 32 | C | C |
| Example 5 | | | |

As seen in the results shown in Table 2-1 and Table 3-2, the receding contact angle of each clear ink in Examples 1 to 18 is 35 degrees or greater and discharging stability is excellent. It was confirmed that the gloss significantly lowered in the low gloss printing mode and the gloss significantly rose in the high gloss printing mode in Examples 1 to 18, in which Tₘₐₜₜₑ>T_{gloss}, in comparison with Comparative Examples 1 and 2, in which Tₘₐₜₜₑ−T_{gloss}, and Comparative Example 4, in which Tₘₐₜₜₑ<T_{gloss}.

Also, when Example 1 and Example 2 are compared, a large gloss change occurred in Example 1, in which D_{gloss}−Dₘₐₜₜₑ was 60 percent, in comparison with Example 2, in which D_{gloss}−Dₘₐₜₜₑ was 10 percent.

When compared with Examples 3, 4, and 6, the gloss change by clear ink printing is large as the amount of resin contained in the clear ink increases. A large gloss change was achieved in Examples 4 and 6, in which the proportion of the resin in clear ink was 8 percent by mass or greater, in comparison with Example 3, in which the proportion of the resin in clear ink was less than 8 percent by mass.

Also, it was found that, in the low gloss printing mode, the gloss significantly changed in Example 5 where the proportion of the surfactant was two or less percent by mass in comparison with Example 4 where the proportion of the surfactant surpassed 2 percent by mass.

When Examples 8 where the clear ink was applied onto the magenta ink film was compared with Comparative Example 3 where the magenta ink was singly applied, it was found that the degree of gloss decreased in the low gloss printing mode and increased in the high gloss printing mode.

Aspects of the present disclosure are, for example, as follows.

(1) An inkjet printing device includes an ink container accommodating a clear ink containing a resin and an organic solvent, a discharging head including a nozzle plate, the discharging head being configured to discharge the clear ink onto a substrate to form a printing layer on the substrate, and a heating device configured to heat the substrate, wherein the heating device heats the substrate satisfying the following relationship:

Tₘₐₜₜₑ (degrees C.)>T_{gloss} (degrees C.), where Tₘₐₜₜₑ represents the temperature of the substrate in a first printing region when the clear ink is attached to the substrate in a first printing mode and T_{gloss} represents the temperature of the substrate in a second printing region when the clear ink is attached to the substrate in a second printing mode, wherein the receding contact angle of the clear ink against the nozzle plate is 35 degrees or greater.

(2) The inkjet printing device according to (1) mentioned above, wherein the nozzle plate has an ink repellent film containing a fluorinated polyacrylate.

(3) The printing device according to (2) mentioned above, wherein the fluorine-containing acrylate ester polymer contains a polymer obtained by polymerizing at least one of the compound represented by the following Chemical Formula I and the compound represented by the following Chemical Formula 11,

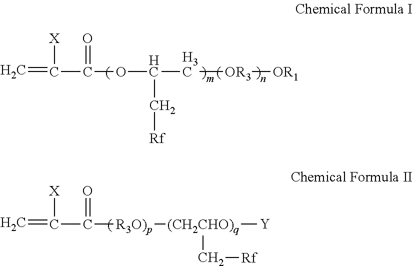

where, in Chemical Formula I and Chemical Formula II, X represents a hydrogen atom, linear or branched alkyl group having 1 to 21 carbon atoms, halogen atom, CFX₁X₂ group, where X₁ and X₂ each independently represent hydrogen atoms or halogen atoms, cyano group, linear or branched fluoroalkyl group having 1 to 21 carbon atoms, substituted or non-substituted benzyl group, and substituted or non-substituted phenyl group, R₁ represents an alkyl group having 1 to 18 carbon atoms, R₂ represents an alkylene group having 2 to 6 carbon atoms, R₃ represents an alkylene group having 2 to 6 carbon atoms, Y represents an acid group, Rf represents a linear or branched fluoroalkyl group having 1 to 21 carbon atoms, m represents an integer of from 1 to 10, n represents an integer of from 2 to 90, p represents an integer of from 1 to 90, and q represents an integer of from 1 to 10.

(4) The inkjet printing device according to (3) mentioned above, wherein the fluorinated polyacrylate contains a polymer having at least one of the structural unit represented by the following Chemical Formula III and the structural unit represented by the following Chemical Formula IV,

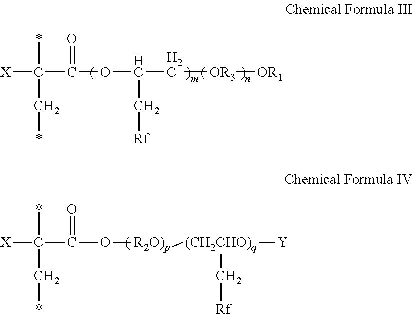

where, in Chemical Formula III and Chemical Formula IV, X represents a hydrogen atom, linear or branched alkyl group having 1 to 21 carbon atoms, halogen atom, CFX₁X₂ group, where X₁ and X₂ each, independently represent hydrogen atoms or halogen atoms, cyano group, linear or branched fluoroalkyl group having 1 to 21 carbon atoms, substituted or non-substituted benzyl group, and substituted or non-substituted phenyl group, R₁ represents an alkyl group having 1 to 18 carbon atoms, R₂ represents an alkylene group having 2 to 6 carbon atoms, R₃ represents an alkylene group having 2 to 6 carbon atoms, Y represents an acid group, Rf represents a linear or branched fluoroalkyl group having 1 to 21 carbon atoms, m represents an integer of from 1 to 10, n represents an integer of from 2 to 90, p represents an integer of from 1 to 90, and q represents an integer of from 1 to 10.

(5) The inkjet printing device according to any one of (2) to (4) mentioned above, wherein the ink repellent film contains a polymer having a fluorinated heterocyclic structure in the main chain.

(6) The inkjet printing device according to any one of (1) to (5) mentioned above, wherein the heating device heats the substrate satisfying the following relationship: Tₘₐₜₜₑ−T_{gloss}≥10 degrees C.

(7) The inkjet printing device according to any one of (1) to (6) mentioned above, wherein the following relationship is satisfied: Gₘₐₜₜₑ>G_{gloss}, where Gₘₐₜₜₑ represents the degree of gloss of the substrate for use in the first printing mode and G_{gloss} represents the degree of gloss of the substrate for use in the second printing mode.

(8) The printing device according to any one of (1) to (7) mentioned above, wherein the proportion of the resin in the clear aqueous ink is 8 percent by mass or more.

(9) The inkjet printing device according to any one of (1) to (8) mentioned above, wherein the resin includes a polyurethane resin.

(10) The inkjet printing device according to any one of (1) to (9) mentioned above, wherein the clear ink further contains a surfactant and the proportion of the surfactant in the non-clear aqueous ink is 3 percent by mass or less.

(11) The inkjet printing device according to (10) mentioned above, wherein the surfactant is a polyether-modified siloxane compound.

(12) An inkjet printing method includes discharging a clear ink from an ink discharging head including a nozzle plate to a substrate to form a printing layer and heating the substrate on which the printing layer has been formed,

wherein the clear ink contains a resin and water, wherein, in the heating, the heating device heats the substrate satisfying the following relationship:
Tₘₐₜₜₑ (degrees C.)>T_{gloss} (degrees C.), where Tₘₐₜₜₑ represents the temperature of the substrate in a first printing region when the clear ink is attached to the substrate in a first printing mode and T_{gloss} represents the temperature of the substrate in a second printing region when the clear ink is attached to the substrate in a second printing mode, wherein the receding contact angle of the clear ink against the nozzle plate is 35 degrees or greater.

(13) The method of controlling the gloss of print image include discharging a clear ink containing a resin and water from an ink discharging head to a substrate to form a printing layer, heating the substrate on which the printing layer has been formed, wherein the method has a first printing mode and a second printing mode, wherein the following relationship is satisfied: Tₘₐₜₜₑ degrees C.>T_{gloss} degrees C., where Tₘₐₜₜₑ represents the temperature of the substrate in the heating in the printing region printed in the first printing mode when the clear ink is attached to the substrate and T_{gloss} represents the temperature of the substrate in the heating in the printing region printed in the second printing mode when the clear ink is attached to the substrate, wherein the receding contact angle of the clear ink against the nozzle plate of the ink discharging head is 35 degrees or greater.

(14) An inkjet printing device includes an ink container accommodating a clear ink containing a resin having a glass transition temperature Tg of 50 degrees C. or higher and water, a discharging head including a nozzle plate, the discharging head being configured to discharge the clear ink onto a substrate to form a printing layer on the substrate and a heating device configured to heat the substrate,

wherein the heating device heats the substrate satisfying the following relationship: HTₘₐₜₜₑ (degrees C.)>HT_{gloss} (degrees C.), where HTₘₐₜₜₑ represents the temperature of the heating device in a first printing mode and HT_{gloss} represents the temperature of the heating device in a second printing mode, wherein the receding contact angle of the clear ink against the nozzle plate is 35 degrees or greater.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An inkjet printing device comprising:
an ink container accommodating a clear ink comprising a resin and an organic solvent;
a discharging head including a nozzle plate, the discharging head being configured to discharge the clear ink onto a substrate to form a printing layer on the substrate; and
a heating device configured to heat the substrate,
wherein the heating device heats the substrate satisfying the following relationship: Tₘₐₜₜₑ (degrees C.)>T_{gloss} (degrees C.), where Tₘₐₜₜₑ represents a temperature of the substrate in a first printing region when the clear ink is attached to the substrate in a first printing mode and T_{gloss} represents a temperature of the substrate in a second printing region when the clear ink is attached to the substrate in a second printing mode,
wherein a receding contact angle of the clear ink against the nozzle plate is 35 degrees or greater.

2. The inkjet printing device according to claim 1, wherein the nozzle plate has an ink repellent film containing a fluorinated polyacrylate.

3. The inkjet printing device according to claim 2,
wherein the fluorinated polyacrylate comprises a polymer obtained by polymerizing at least one of a compound represented by the following Chemical Formula I and a compound represented by the following Chemical Formula II, 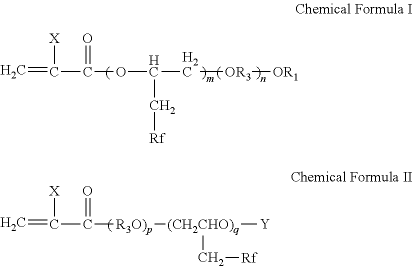
where, in Chemical Formula I and Chemical Formula II, X represents a hydrogen atom, linear or branched alkyl group having 1 to 21 carbon atoms, halogen atom, CFX₁X₂ group, where X₁ and X₂ each independently represent hydrogen atoms or halogen atoms, cyano group, linear or branched fluoroalkyl group having 1 to 21 carbon atoms, substituted or non-substituted benzyl group, or substituted or non-substituted phenyl group, R₁ represents an alkyl group having 1 to 18 carbon atoms, R₂ represents an alkylene group having 2 to 6 carbon atoms, R₃ represents an alkylene group having 2 to 6 carbon atoms, Y represents an acid group, Rf represents a linear or branched fluoroalkyl group having 1 to 21 carbon atoms, m represents an integer of from 1 to 10, n represents an integer of from 2 to 90, p represents an integer of from 1 to 90, and q represents an integer of from 1 to 10.

4. The inkjet printing device according to claim 3,
wherein the fluorinated polyacrylate contains a polymer having at least one of a structural unit represented by the following Chemical Formula III and a structural unit represented by the following Chemical Formula IV, 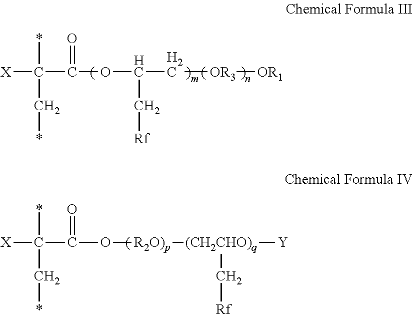
where, in Chemical Formula III and Chemical Formula IV, X represents a hydrogen atom, linear or branched alkyl group having 1 to 21 carbon atoms, halogen atom, CFX₁X₂ group, where X₁ and X₂ each independently represent hydrogen atoms or halogen atoms, cyano group, linear or branched fluoroalkyl group having 1 to 21 carbon atoms, substituted or non-substituted benzyl group, or substituted or non-substituted phenyl group, R₁ represents an alkyl group having 1 to 18 carbon atoms, R₂ represents an alkylene group having 2 to 6 carbon atoms, R₃ represents an alkylene group having 2 to 6 carbon atoms, Y represents an acid group, Rf represents a linear or branched fluoroalkyl group having 1 to 21 carbon atoms, m represents an integer of from 1 to 10, n represents an integer of from 2 to 90, p represents an integer of from 1 to 90, and q represents an integer of from 1 to 10.

5. The inkjet printing device according to claim 2, wherein the ink repellent film contains a polymer having a fluorinated heterocyclic structure in a main chain.

6. The inkjet printing device according to claim 1, wherein the heating device heats the substrate satisfying the following relationship: Tₘₐₜₜₑ−T_{gloss}>10 degrees C.

7. The inkjet printing device according to claim 1, wherein the following relationship is satisfied: Gₘₐₜₜₑ>G_{gloss}, where Gₘₐₜₜₑ represents a degree of gloss of the substrate for use in the first printing mode and G_{gloss} represents a degree of gloss of the substrate for use in the second printing mode.

8. The inkjet printing device according to claim 1, wherein a proportion of the resin in the clear ink is 8 percent by mass or greater.

9. The inkjet printing device according to claim 1, wherein the resin comprises a polyurethane resin.

10. The inkjet printing device according to claim 1, wherein the clear ink further comprises a surfactant, wherein a proportion of the surfactant in the clear ink is 3 percent by mass or less.

11. The inkjet printing device according to claim 10, wherein the surfactant comprises a polyether-modified siloxane compound.

12. An inkjet printing method comprising:
discharging a clear ink from an ink discharging head including a nozzle plate to a substrate to form a printing layer; and
heating the substrate on which the printing layer has been formed,
wherein the clear ink comprises a resin and water,
wherein, in the heating, the heating device heats the substrate satisfying the following relationship:
Tₘₐₜₜₑ(degrees C.)>T_{gloss}(degrees C.),
where Tₘₐₜₜₑ represents a temperature of the substrate in a first printing region when the clear ink is attached to the substrate in a first printing mode and T_{gloss} represents a temperature of the substrate in a second printing region when the clear ink is attached to the substrate in a second printing mode,
wherein a receding contact angle of the clear ink against the nozzle plate is 35 degrees or greater.

13. An inkjet printing device comprising:
an ink container accommodating a clear ink comprising a resin having a glass transition temperature Tg of 50 degrees C. or higher and water;
a discharging head including a nozzle plate, the discharging head being configured to discharge the clear ink onto a substrate to form a printing layer on the substrate; and
a heating device configured to heat the substrate,
wherein the heating device heats the substrate satisfying the following relationship:
HTₘₐₜₜₑ(degrees C.)>HT_{gloss}(degrees C.),
where HTₘₐₜₜₑ represents a temperature of the heating device in a first printing mode and HT_{gloss} represents a temperature of the heating device in a second printing mode,
wherein a receding contact angle of the clear ink against the nozzle plate is 35 degrees or greater.
